(19) United States
(12) Patent Application Publication
(10) Pub. No.: US 2022/0176329 A1
(43) Pub. Date: Jun. 9, 2022

(54) DISPERSION SYSTEM, TREATMENT METHOD AND CHEMICAL REACTION APPARATUS

(71) Applicant: NEC Corporation, Minato-ku, Tokyo (JP)

(72) Inventor: Hidefumi HIURA, Tokyo (JP)

(73) Assignee: NEC Corporation, Minato-ku, Tokyo (JP)

(21) Appl. No.: 17/436,317

(22) PCT Filed: Jan. 6, 2020
(86) PCT No.: PCT/JP2020/000039

§ 371 Date: Sep. 3, 2021

(30) Foreign Application Priority Data
Mar. 20, 2019 (JP) 2019-053611

(51) Int. Cl. B01F 23/50; B01J 4/00; B01J 19/12; B01F 23/40

(52) U.S. Cl. CPC B01F 23/511; B01J 4/001; G02B 26/001; B01F 23/58; B01F 23/48; B01J 19/128

(57) ABSTRACT

A microsphere cavity that forms a whispering gallery mode is used. By vibrationally coupling a whispering gallery mode being one of kinds of an optical mode to a vibrational mode of water or a liquid other than water, ultra strong coupling water or a liquid in a vibrational coupling state is generated. A first example is to acquire aerosol in which water itself or a liquid itself other than water constitutes a micro-water sphere cavity or a micro-liquid sphere cavity (50) and is a dispersoid. A second example is to acquire colloid or emulsion in which a micro-dielectric sphere cavity (53) is a dispersoid and water or a liquid other than water is a dispersion medium.

### TECHNICAL FIELD

The present invention relates to a dispersion system, a treatment method, and a chemical reaction, based on vibrational coupling.

### BACKGROUND ART

Water is the most important matter on the earth. Water is an essential matter from any viewpoint of the global environment, a vital activity, and an economic activity of human. As compared with the same group of materials, water has extremely high melting point and boiling point, and is liquid in an extremely wide temperature range of 0 to 100°. In this way, physical properties of water are peculiar. Further, water also has a chemical property that a capacity of dissolving various matters is exceptionally high, and water is an indispensable presence as a medium and a reactive raw material of a variety of chemical reactions from photosynthesis to industrial synthesis. Further, energy is produced by using water going back and forth among three forms of gas (vapor), liquid (water), and a solid (ice). Further, water serves as a solvent of various matters, a dispersoid of aerosol, or a dispersion medium of colloid or emulsion, and is useful in a wide field from everyday life to various industrial activities. As described above, water itself has the most versatile function among matters. Meanwhile, in recent years, an attempt to provide a new function to water has also been made.

For example, according to PTL 1, a method of converting a chemical/physical property of water by using vibrational ultra strong coupling between an optical mode of a cavity and a vibrational mode of water, particularly, a method of accelerating a chemical reaction have been developed. Water in a vibrational ultra strong coupling state is referred to as ultra strong coupling water, and has extremely high reactivity. However, since it is difficult to manufacture ultra strong coupling water in large quantity, use into industry has not been advanced.

Further, as a new method of accelerating a chemical reaction, for example, PTL 2 discloses a method of using vibrational coupling between an optical mode of an optical system and a vibrational mode of a chemical matter vibrational system. This method uses a principle of reducing vibrational energy of a chemical matter, based on vibrational coupling, reducing activation energy of a chemical reaction related to the vibrational mode, and increasing a reaction rate as a result.

Meanwhile, as a new method of controlling a chemical reaction, for example, PTL 3 discloses a method of using coupling between an electromagnetic wave and a matter. This method includes a step of causing a reflection structure or a photonic structure having an electromagnetic mode that resonates with transition in a molecule, a biomolecule, or a matter, and a step of disposing the molecule, the biomolecule, or the matter described above inside or on the structure of the type described above.

### RELATED DOCUMENT

### Patent Document

[PTL 1] WO 2018/211820 A1

[PTL 2] WO 2018/038130 A1

[PTL 3] Japanese Patent Application Publication (Translation of PCT Application) No. 2014-513304

### SUMMARY OF THE INVENTION

### Technical Problem

As described above, a liquid in a vibrational coupling state such as ultra strong coupling water is useful. Thus, when a dispersing element including, as at least a part of a dispersoid, the liquid in the vibrational coupling state can be manufactured, the dispersing element can be used for various uses. However, in the related art, a necessary requirement is to install an external cavity (such as a Fabry-Perot cavity and a surface plasmon structure) having a macro structure for generation of ultra strong coupling water or a liquid in a vibrational coupling state. Since an effective range of the external cavity is approximately few micrometers at most, it is difficult to form the dispersing element described above in the first place, and a significant amount cannot be acquired even when the dispersing element described above can be formed.

One example of an object of the present invention is to provide a dispersion system including a liquid in a vibrational coupling state.

### Solution to Problem

The present invention provides a dispersion system including:

a spherical body, as a dispersoid, formed of a liquid in a vibrational coupling state, wherein

a whispering gallery mode in which the spheric state of the liquid is spontaneously formed and a vibrational mode of the liquid are resonantly coupled to each other.

The present invention provides a dispersion system including:

a spheric state that serves as a dispersoid, and is formed of a dielectric;

a liquid being a dispersion medium of the spheric state, wherein

a whispering gallery mode in which the spheric state of the dielectric is spontaneously formed and a vibrational mode of the liquid are resonantly coupled to each other.

The present invention provides a treatment method including

using the dispersion system described above for a chemical reaction.

The present invention provides a chemical reaction apparatus being used in the treatment method described above, and including at least:

a reaction container in which the chemical reaction is performed;

an introduction port for introducing the dispersion system into the reaction container; and

a discharge port for discharging a reactant by the chemical reaction.

### Advantageous Effects of Invention

The present invention is able to provide a dispersion system including a liquid in a vibrational coupling state.

### BRIEF DESCRIPTION OF THE DRAWINGS

The above-described object, the other objects, features, and advantages will become more apparent from suitable example embodiments described below and the following accompanying drawings.

FIGS. 1A and 1B are schematic diagrams representing a principle of vibrational coupling.

FIGS. 2A and 2B are infrared transmission spectra representing generation of ultra strong coupling water.

FIGS. 3A and 3B are diagrams representing a comparison of chemical reactivity between normal water and ultra strong coupling water.

FIGS. 4A and 4B are schematic diagrams representing a comparison between a TE mode and a TM mode.

FIGS. 5A to 5D are schematic diagrams representing dependence of a light intensity distribution of a WG mode on an argument mode.

FIGS. 6A and 6B are schematic diagrams for explaining a first example embodiment according to the present invention.

FIGS. 7A to 7D are schematic diagrams for explaining the first example embodiment and a second example embodiment according to the present invention.

FIG. 8 is a schematic diagram of a chemical reaction system according to the first example embodiment of the present invention.

FIGS. 9A and 9B are schematic diagrams of chemical reaction systems according to the second example embodiment of the present invention.

FIGS. 10A and 10B are diagrams representing a relationship between a resonance frequency of the WG mode and a diameter of a micro-water sphere.

FIGS. 11A and 11B are diagrams representing dependence of a resonance diameter on a radial mode number and an argument mode number.

FIGS. 12A and 12B are diagrams representing an electric field intensity distribution of the WG mode leaking from a micro-dielectric sphere cavity.

FIGS. 13A and 13B are diagrams representing a relationship between a resonance diameter and a relative refractive index of the micro-dielectric sphere cavity.

FIGS. 14A and 14B are three-dimensional diagrams representing a relationship among a resonance diameter, a molecular frequency, and a relative refractive index of a microsphere cavity when a liquid other than water is used.

### DESCRIPTION OF EMBODIMENTS

Next, example embodiments of the present invention will be described with reference to drawings.

First, a main portion of the present example embodiment will be described. In the present example embodiment, a microsphere cavity that spontaneously forms a whispering gallery (WG) mode is used. Specifically, by vibrationally coupling the WG mode being one of kinds of an optical mode to a vibrational mode of liquid (for example, water), a liquid in a vibrational coupling state such as ultra strong coupling water is generated. This generation means is classified into two kinds below depending on a use of a microsphere cavity. A first means constitutes a micro-water sphere cavity or a micro-liquid sphere cavity with a liquid itself being a spherical body. In this case, aerosol including a dispersoid in a vibrational ultra strong coupling state or a vibrational coupling state is acquired. In a second means, a micro-dielectric sphere cavity is a dispersoid, and a liquid located around the dispersoid is a dispersion medium in a vibrational ultra strong coupling state or a vibrational coupling state. In this case, colloid or emulsion is acquired.

Note that, in order for a microsphere cavity to operate, a micro-water sphere or a macro-dielectric sphere does not always need to be a complete sphere (true sphere). Even when the sphere is a flat ellipsoid of revolution being stretched in one axis direction, the microsphere cavity acts as a cavity and there is no harm in forming a WG mode as long as an equatorial (great circle) plane is a perfect circle or has a shape close to a perfect circle to such an extent that the WG mode is formed. Therefore, even when a microsphere is a flat ellipsoid of revolution, aerosol, colloid, or emulsion according to the present invention can be acquired. Further, a shape of a microsphere may dynamically fluctuate within a certain range. As exemplified in an example, for example, in a case where water is a dispersoid or a dispersion medium, when aerosol, colloid, or emulsion of ultra strong coupling water is acquired, a fluctuation in resonance diameter by about 6% is permitted. When this permissible degree is converted into flattening rate f (an indicator representing a degree of flatness from a true sphere, f=1−b/a, a: long radius, b: short radius), a value is about 0.11. In other words, even when a microsphere has a shape dynamically changing within in a range of flattening rate of 0 to 0.11, aerosol, colloid, or emulsion of ultra strong coupling water can be acquired.

The first means described above has a characteristic that a cavity is formed of only liquid. In other words, liquid is integral with a cavity. In this means, a spherical liquid in a vibrational ultra strong coupling state or a vibrational coupling state is self-sufficiently generated in aerosol. In the aerosol, a spherical body formed of liquid has a diameter of a micrometer order, does not require installation of a macro external structure and injection of external energy, and is self-sufficient. Then, since an external cavity is unnecessary, a cost of manufacturing can be reduced. Further, without restraint of an external cavity, a liquid in a vibrational ultra strong coupling state or a vibrational coupling state can be manufactured in desired quantity at a desired place.

The second means described above has a characteristic that a WG mode leaking from a micro-dielectric sphere cavity is used for vibrational coupling. By vibrationally coupling this leaking WG mode to a vibrational mode of a liquid present around the micro-dielectric sphere cavity, a liquid in a vibrational ultra strong coupling state or a vibrational coupling state is acquired. In broad perspective, colloid or emulsion in which a micro-dielectric sphere cavity is a dispersoid and a liquid is a dispersion medium is acquired. The dielectric being a dispersoid has a diameter of a micrometer order, and is dispersed in the liquid being a dispersion medium. Manufacturing of colloid or emulsion can be scaled up, and thus a liquid in a vibrational ultra strong coupling state or a vibrational coupling state can be produced in desired bulk quantity. Furthermore, since a macro external cavity taking space is unnecessary, industrial use is facilitated. For example, in addition to that a useful matter using a liquid in a vibrational ultra strong coupling state or a vibrational coupling state can be produced in large quantity, a large-scale facility for decomposing a harmful matter, purifying water, and the like can also be constructed at low cost by using a liquid in a vibrational ultra strong coupling state or a vibrational coupling state.

In all of the cases described above, when a liquid in an ultra strong coupling state or a vibrational coupling state is generated, an external cavity is unnecessary. Furthermore, ultra strong coupling water or a liquid in a vibrational coupling state can be generated in desired quantity at any place in a three-dimensional free space. The reason is that there is no restraint of an external cavity.

Further, when a spherical body of a micro-dielectric dispersed in liquid is used as a cavity, a liquid in an ultra strong coupling state or a vibrational coupling state can be acquired in large quantity as necessary. The reason is that, by vibrationally coupling a WG mode seeping from a micro-dielectric sphere cavity to a vibrational mode of a liquid, the entire liquid being a dispersion medium can be converted into a liquid in an ultra strong coupling state or a vibrational coupling state.

Then, when a dispersion system such as the aerosol, the colloid, or the emulsion described above is used, a treatment method to which a variety of chemical reactions are applied can be achieved. The reason is that the dispersion system described above has high reactivity.

Then, a chemical reaction apparatus using the treatment method can be easily acquired. The reason is that the dispersion system described above does not require an external cavity taking space, and thus the apparatus can be easily constructed and easily scaled up.

Hereinafter, before description of an example embodiment according to the present invention, three points of (1) vibrational coupling, (2) ultra strong coupling water, and (3) WG mode that are a basis of the present invention will be described.

### (1) Vibrational Coupling

### (1-1) Principle of Vibrational Coupling

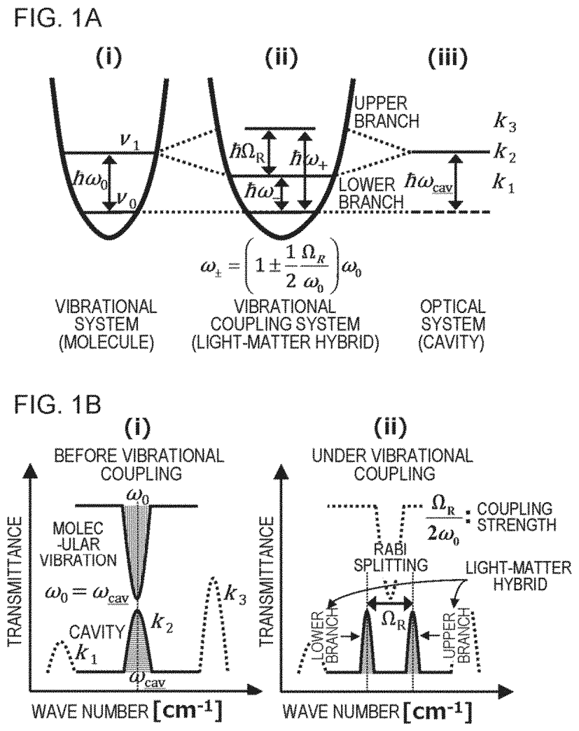

FIGS. 1A and 1B are schematic diagrams illustrating a principle of vibrational coupling according to the example embodiment of the present invention. FIG. 1A is an energy level diagram related to vibrational coupling. (i) represents an energy level of a vibrational system (molecule) on which vibrational coupling is to be performed, (ii) represents an energy level of a vibrational strong coupling system (light-matter hybrid) on which vibrational coupling is performed, and (iii) represents an energy level of an optical system (cavity) on which vibrational coupling is to be performed. Further, FIG. 1B schematically represents a change in infrared transmission spectrum when vibrational coupling is observed. (i) corresponds to a spectrum of a molecule and a cavity before vibrational coupling, and (ii) corresponds to a spectrum of a light-matter hybrid under vibrational coupling. Note that, herein, it is assumed that vibrational coupling between a vibrational mode having a frequency ω₀ and a second optical mode k₂ having a frequency ω_{cav} is performed.

In FIG. 1A, with a molecule placed in a light confinement structure such as a cavity, when a frequency ω₀ of molecular vibration coincides with a frequency ω_{cav} of the cavity, i.e., when a resonance condition of ω₀=ω_{cav} is satisfied, the vibrational mode and the optical mode are resonantly coupled to each other, and thus a Rabi splitting phenomenon occurs. As a result, new two states in which light and a matter are mixed, which are an upper branch state (on a high wave number side) and a lower branch state (on a low wave number side), are generated. An interaction between light and a matter in this vibration state is vibrational coupling. This phenomenon is regarded as coupling in a vibration state between a vacuum field and a matter. Note that, a system in which vibrational coupling is performed is referred to as a light-matter hybrid. Further, an energy difference between the two upper branch and lower branch states is referred to as Rabi splitting energy:

ℏΩ_{R} [Math 1]

and described in a following equation (1).

$$\begin{matrix}[ Math 2 ] & \\ {ℏΩ}_{R} = 2 \sqrt{N} Ed = 2 \sqrt{N} \sqrt{\frac{{ℏω}_{0}}{2 {ɛ}_{0} V}} d \sqrt{{n}_{ph} + 1} & ( 1 )\end{matrix}$$

### Herein,

ℏ [Math 3]

is a Dirac constant (acquired by dividing Planck constant h by 2π), Ω_{R} is a Rabi frequency, N is the number of molecules (density) in unit volume, E is electric field intensity of a vacuum field, d is a transition dipole moment of molecular vibration, nₚₕ is the number of photons, ω₀ is a molecular frequency, ε₀ is a dielectric constant in vacuum, and V is mode volume.

The most important point in the equation (1) is that, even when the number of photons is zero, i.e., nₚₕ=0 due to a quantum fluctuation in a vacuum field,

ℏQ_{R} [Math 4]

has a finite value. In other words, it may seem paradoxical, but presence of light is not an essential condition for generation of a light-matter hybrid. It is sufficient as long as only a light confinement structure such as a cavity that form a vacuum field is present. As a matter of course, it is completely unnecessary to apply an electromagnetic wave such as infrared light from the outside and inject other energy. This point is a difference that clearly distinguishes a phenomenon being vibrational coupling from a phenomenon such as laser oscillation, optical excitation, and vibrational excitation.

A degree of vibrational coupling has a variation in intensity. A half of a ratio of Ω_{R} and ω₀, i.e., Ω_{R}/2ω₀ is referred to as a coupling ratio, and serves as a relative indicator representing intensity of vibrational coupling. Vibrational coupling is classified by magnitude of a coupling ratio, and, in an ascending order of an interaction, a range of Ω_{R}/2ω₀<<0.01, a range of 0.01≤Ω_{R}/2ω₀<0.1, and a range of 0.1<Ω_{R}/2ω₀<1 are referred to as vibrational weak coupling, vibrational strong coupling, and vibrational ultra strong coupling, respectively. An influence on physical properties increases with a greater coupling ratio of Ω_{R}/2ω₀. As described in a next section (1-2), ultra strong coupling water has the coupling ratio of Ω_{R}/2ω₀ of a highest level among reported matters, and has extremely high reactivity being the highest in the matters.

### (1-2) Method of Practicing Vibrational Coupling

In FIG. 1B, in (i) before vibrational coupling, a vibrational mode of a molecule and an optical mode of a cavity provide an individual infrared transmission spectrum. In contrast, in (ii) under vibrational coupling in which the resonance condition of ω₀=ω_{cav} is satisfied by adjusting the cavity, the vibrational mode and the optical mode are resonantly coupled to each other, Rabi splitting occurs, and two peaks appear with a splitting width of Ω_{R}. A peak having a greater wave number corresponds to an upper branch state, a peak having a smaller wave number corresponds to a lower branch state, and both of the states constitute a light-matter hybrid.

In a reference technique of the present invention, a Fabry-Perot cavity formed of one set of parallel mirror surfaces is used for forming an optical mode for vibrational coupling. A resonance frequency ω_{cav} of an optical mode of the Fabry-Perot cavity is a function of a distance (a cavity length, approximately a few micrometers) between the mirror surfaces, and is defined by one kind of an optical mode number kᵢ (i=1, 2, 3, . . . ). In an ascending order of wave number, the optical modes are referred to as a first optical mode (k₁), a second optical mode (k₂), and a third optical mode (k₃). In a case of the Fabry-Perot cavity, the resonance condition of ω₀=ω_{cav} is experimentally achieved by adjusting a cavity length. In contrast, the present invention uses a WG mode of a microsphere cavity as an optical mode for vibrational coupling. As described later, a resonance frequency ω_{cav} of the WG mode is a function of a diameter of a microsphere, and is defined by three kinds of optical mode numbers (see (3-3)).

### (2) Ultra Strong Coupling Water

### (2-1) Generation of Ultra Strong Coupling Water

Ultra strong coupling water refers to water has physical properties, that is generated by extremely strong vibrational coupling between a vibrational mode of OH stretching of water and an optical mode of a cavity, different from those of normal water. For example, as compared with normal water, ultra strong coupling water has extremely high reactivity and also has a melting point appearing to rise. Three kinds of light water (H₂O), heavy water (D₂O), and tritiated water (T₂O, T: tritium) are present in water according to an isotope of hydrogen, but when vibrational coupling to an optical mode of a cavity is performed as exemplified next, it is experimentally confirmed that at least light water (H₂O) and heavy water (D₂O) become ultra strong coupling water.

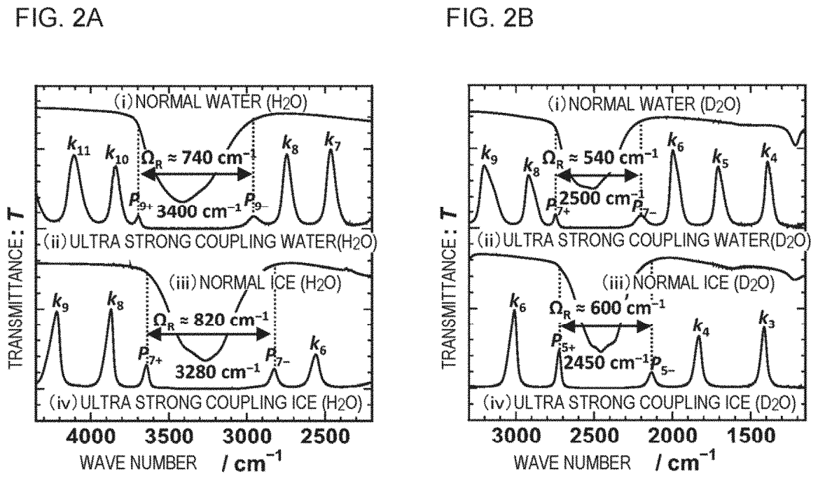

FIGS. 2A and 2B are infrared transmission spectra representing vibrational ultra strong coupling between a stretching vibrational mode of pure water and an optical mode. FIG. 2A illustrates a case of light water (H₂O), and FIG. 2B illustrates a case of heavy water (D₂O), and (i), (ii), (iii), and (iv) correspond to an infrared spectrum of normal water (liquid), ultra strong coupling water (liquid), normal ice (solid), and ultra strong coupling ice (solid), respectively.

As illustrated in (ii) in FIG. 2A, when vibrational coupling is resonantly (ω₀=ω_{cav}) performed on a vibrational mode (ω₀=3400 cm⁻¹) of OH stretching of light water (H₂O) being liquid and an optical mode (ω_{cav}=3400 cm⁻¹, ninth optical mode) of a cavity, water formed of pure H₂O becomes ultra strong coupling water having Rabi splitting energy

ℏΩ_{R} [Math 5]

of approximately 740 cm⁻¹ and a coupling ratio of Ω_{R}/2ω₀=0.113 (average value). Further, as illustrated in (iv) in FIG. 2A, when vibrational coupling is resonantly (ω₀=ω_{cav}) performed on a vibrational mode (ω₀=3280 cm⁻¹) of OH stretching of light water (H₂O) being a solid and an optical mode (ω_{cav}=3280 cm⁻¹, seventh optical mode) of the cavity, ice formed of pure H₂O becomes ultra strong coupling ice having Rabi splitting energy

ℏΩ_{R} [Math 6]

of approximately 820 cm⁻¹ and a coupling ratio of Ω_{R}/2ω₀=0.129 (average value). Similarly, water (ice) formed of pure D₂O each become ultra strong coupling water (ultra strong coupling ice) having Rabi splitting energy

ℏΩ_{R} [Math 7]

of approximately 540 (600) cm⁻¹ and a coupling ratio of Ω_{R}/2ω₀=0.111 (0.123) (average value) (see (ii) and (iv) in FIG. 2B).

Herein, a point that deserves special mention is that ultra strong coupling water and ultra strong coupling ice have the highest coupling ratio of Ω_{R}/2ω₀ among matters reported up to now. A result of earnest research makes it clear that the reason above is the following two points. The first reason is that a transition dipole moment d included in the OH (OD) stretching vibrational mode is great. In cases of water of light water (OH stretching), ice of light water (OH stretching), water of heavy water (OD stretching), and ice of heavy water (OD stretching), a transition dipole moment is d=0.41 D, d=0.50 D, d=0.35 D, and d=0.42 D (D: debye, 3.336×10⁻³⁰ C m), respectively, and is more than twice as much as a transition dipole moment in a general vibrational mode. With reference to the equation (1), Rabi splitting energy

ℏQ_{R} [Math 8]

is proportional to d, and thus a coupling ratio of Ω_{R}/2ω₀ also increases with greater d. The second reason is that density of water and ice is extremely great. The density of water and ice is actually the greatest among matters near normal temperature and normal pressure, and the reason is that water and ice have a minute molecular structure. With reference to the equation (1),

ℏQ_{R} [Math 9]

is proportional to a square root of density N, and thus a coupling ratio of Ω_{R}/2ω₀ also increases with greater N. Note that, in consideration of the two points described above, tritiated water (T₂O) also has great d and N, and is thus expected to have Ω_{R}/2ω₀ equal to light water and heavy water under vibrational coupling and to become ultra strong coupling water.

Characteristics that deserve special mention in relation to ultra strong coupling water and ultra strong coupling ice are the following five points:

(1) When an optical mode is vibrationally coupled to a stretching vibrational mode of water/ice, a value of a coupling ratio of Ω_{R}/2ω₀ does not change even with any optical mode number being used. In other words, Ω_{R}/2ω₀ does not depend on an optical mode number. This law also holds true in the WG mode.
(2) Ultra strong coupling water and ultra strong coupling ice have the highest coupling ratio of Ω_{R}/2ω₀ among matters.
(3) Even when light water (H₂O) and heavy water (D₂O) are mixed, light water (H₂O) and heavy water (D₂O) become ultra strong coupling water/ultra strong coupling ice.
(4) Ultra strong coupling water and ultra strong coupling ice have physical properties different from those of normal water.
(5) Ultra strong coupling water and ultra strong coupling ice have extremely high reactivity (see (2-2)).

### (2-2) Reactivity of Ultra Strong Coupling Water

As exemplified next, ultra strong coupling water has extremely high reactivity.

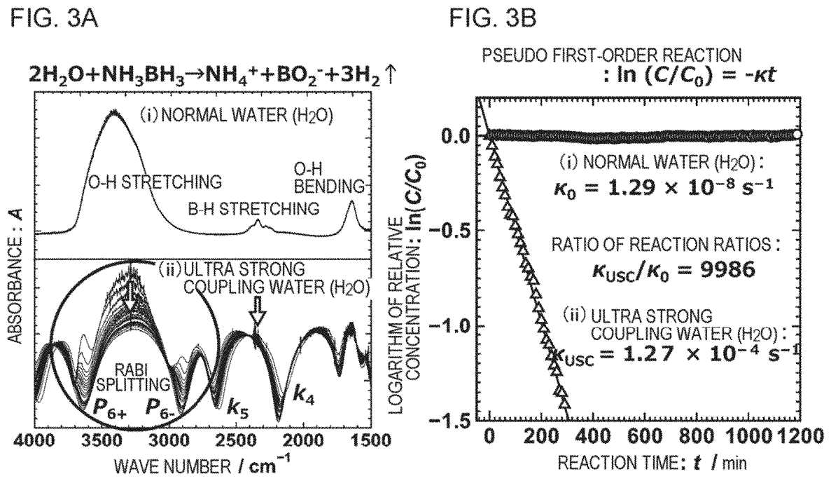

FIGS. 3A and 3B represent a comparison of a hydrolysis reaction of ammonia borane (NH₃BH₃) between normal water and ultra strong coupling water. A chemical equation is as a following equation (2).

2H₂O+NH₃BH₃→NH₄⁺BO₂⁻+3H₂↑ (2)

In FIG. 3A, (i) and (ii) illustrate a change in infrared absorption spectrum during a reaction when normal water and ultra strong coupling water are used, respectively. During a reaction time of about five hours at an initial concentration C₀=1.00 M (M: mol concentration, M=mol dm⁻³) and a room temperature (25° C.), a spectrum rarely changes in hydrolysis by normal water in FIG. 3A. In contrast, in hydrolysis by ultra strong coupling water in FIG. 3B, an infrared absorption band due to BH stretching vibration of ammonia borane (NH₃BH₃) rapidly decreases. Note that, for generation of ultra strong coupling water, vibrational ultra strong coupling between a vibrational mode (ω₀=3400 cm⁻¹) of OH stretching of light water (H₂O) and an optical mode (ω_{cav}=3400 cm⁻¹, sixth optical mode) of a cavity is used.

FIG. 3B is a reaction profile of hydrolysis of ammonia borane (NH₃BH₃), and quantitatively illustrates an observation result described above. Herein, upon a spectrum analysis, a reaction rate constant κ₀ of normal water and a reaction rate constant κ_{USC} of ultra strong coupling water are determined by performing waveform separation on an infrared absorption band due to BH stretching vibration and then converting the absorbance change into a concentration change. Note that, upon an analysis of a rate constant, water (mol concentration of 55.4 M) is a large excess with respect to ammonia borane (NH₃BH₃), and thus a pseudo first-order reaction equation of ln (C/C₀)=−κt (C: concentration during reaction, C₀: initial concentration, κ: reaction rate constant, t: time) is adopted.

As a result of the analysis of the reaction profile, a reaction rate constant of κ₀=1.29×10⁻⁸s⁻¹ in hydrolysis of normal water and a reaction rate constant of κ_{USC}=1.27×10⁻⁴s⁻¹ in hydrolysis of ultra strong coupling water are acquired, and a ratio of both of the reaction rate constants is κ_{USC}/κ₀=9986. In other words, it is proven that ultra strong coupling water has reaction accelerating by about a ten thousand times and exhibits extremely high reactivity as compared with normal water.

Note that, reaction acceleration based on vibrational coupling is also proven other than ultra strong coupling water, and a vacuum field formed by a cavity acts as a catalyst, and thus the reaction acceleration is referred to as cavity catalysis. The strongest cavity catalysis that has been known up to now is achieved by ultra strong coupling water. However, a method of producing ultra strong coupling water in large quantity without restraint of an external cavity has not been known, and the present invention achieves the method for the first time as described later.

### (3) WG Mode

### (3-1) WG Mode and Microsphere

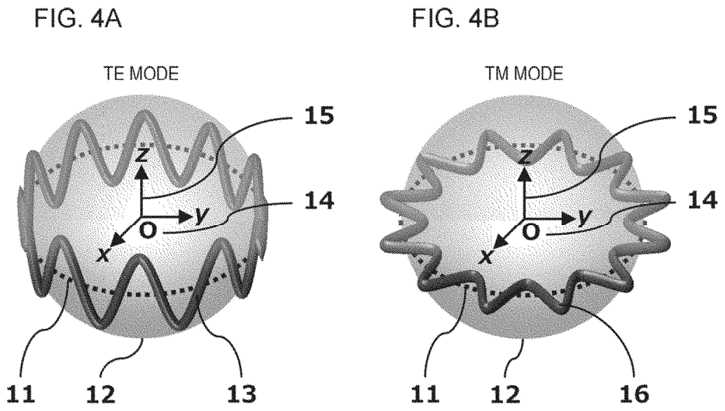

A WG mode refers to an optical mode that circles near a spherical surface of a microsphere formed of a dielectric. Since light is strongly confined in the WG mode, a microsphere has been known to act as an excellent cavity having high a quality factor (Q value). When a length of an equator (great circle) of a sphere becomes an integral multiple of a wavelength of light, i.e., a condition of 2πr=m′λ (r: radius of sphere, λ: wavelength of light, m′: natural number) is satisfied, light resonates and spontaneously forms the WG mode (see FIGS. 4A and 4B). However, in order for light to cause total reflection in the spherical surface, a refractive index n_{cav} inside the sphere needs to be greater than a refractive index nₑₙᵥ of an environment outside the sphere (n_{cav}/nₑₙᵥ>1). Herein, a point to be paid attention to is that an interface of the microsphere has a curvature, and thus total reflection inside the sphere is incomplete, and the WG mode slightly leaks to the outside of the sphere. In the first form described above, the WG mode formed in the sphere is directly used for vibrational coupling, whereas, in the second form described above, the WG mode leaking to the outside of the sphere is used for vibrational coupling. Note that, since a diameter of a microsphere is a micrometer order in the present example embodiment, a microsphere is referred to as a micro-water sphere in the case where a dielectric is water and a micro-dielectric sphere in the case where a dielectric is another dielectric.

(3-2) Polarization State (TE Mode and TM mode) of WG Mode

FIGS. 4A and 4B are schematic diagrams representing a difference between a TE mode and a TM mode that are two kinds of polarization states of the WG mode. Depending on a polarization state, the WG mode formed in a microsphere cavity is classified into a TE mode 13 in which an electric field direction of light is perpendicular to an equatorial plane 11 of a microsphere 12 as illustrated in FIG. 4A, and a TM mode 16 in which an electric field direction is parallel to the equatorial plane 11 as illustrated in FIG. 4B. By using an origin 14 and xyz coordinates 15, it can be expressed that an electric field of the TE mode 13 faces in a z-axis direction and an electric field of the TM mode 16 is located within an xy plane.

(3-3) Mode Number that Defines WG Mode

The WG mode is theoretically defined by three kinds of optical mode numbers, i.e., a radial mode number n (n: natural number) associated with an order of a microsphere in a radial direction, an argument mode number m (m: 0 and natural number) of a microsphere in a circling direction, and an azimuth mode number 1 (1: −m<1<m) of a microsphere in an azimuth direction. On the other hand, it is experimentally the easiest to resonate a basic WG mode (n=1, m=1) that circles near an equator of a microsphere, and a higher-order WG mode greater than n=2 is rarely observed. Therefore, in a discussion related to the WG mode below, while a radial mode number is limited to n=1 or n=2 in view of practical use, dependence of an azimuth mode number 1 is omitted and dependence of an argument mode number m is referred by regarding m=1. Note that, as exemplified in a following equation (3), the argument mode number m is associated with the number of waves of light approximately circling around an equator of a microsphere.

2πR≈Mλ (3)

Herein, r is a radius of a microsphere, and λ is a wavelength of light.

### (3-4) Resonance Diameter of WG Mode

A diameter of a microsphere when the WG mode is formed in the microsphere cavity is referred to as a resonance diameter D. The resonance diameter D [μm] is a function of a resonance frequency ω_{cav} [cm⁻¹], a refractive index ratio nᵣ (n_{cav}/nₑₙᵥ, n_{cav}:refractive index inside microsphere, nₑₙᵥ:refractive index of environment outside sphere) of inside and outside of a microsphere, a radial mode number n, and an argument mode number m, and is represented in equations (4) to (8) exemplified next.

$$\begin{matrix} [ Math 12 ] & \\ D = \frac{{10}^{4}}{{πω}_{cav} {n}_{r}} \{ u + {2}^{- \frac{1}{3}} A ( n ) {u}^{\frac{1}{3}} - \frac{L}{{( {n}_{r}^{2} - 1 )}^{\frac{1}{2}}} + \frac{3}{10} {2}^{- \frac{2}{3}} {A}^{2} ( n ) {u}^{- \frac{1}{3}} - {2}^{- \frac{1}{3}} \frac{L ( {n}_{r}^{2} - \frac{2}{3} {L}^{2} )}{{( {n}_{r}^{2} - 1 )}^{\frac{3}{2}}} A ( n ) {u}^{- \frac{2}{3}} & ( 4 ) \\ L = \{ \begin{matrix}{n}_{r} & ( for TE mode ) \\ \frac{1}{{n}_{r}} & ( for TM mode )\end{matrix} & ( 5 ) \\ [ Math 13 ] & \\ [ Math 14 ] & \\ {n}_{r} = \frac{{n}_{cav}}{{n}_{env}} & ( 6 ) \\ [ Math 15 ] & \\ A ( n ) = \{ \begin{matrix}2.338 & ( for n = 1 ) \\ 4.088 & ( for n = 2 )\end{matrix} & ( 7 ) \\ [ Math 16 ] & \\ u = m + \frac{1}{2} & ( 8 )\end{matrix}$$

Herein, A(n) represents an Airy function (n is a variable where n=1 or 2).

Note that, since a microsphere cavity provides an extremely high Q value, the WG mode is exclusively used for visible laser oscillation to near infrared laser oscillation. The present invention is the first one to use the WG mode for vibrational coupling as far as the inventor confirms.

### (3-5) Intensity Distribution of WG Mode

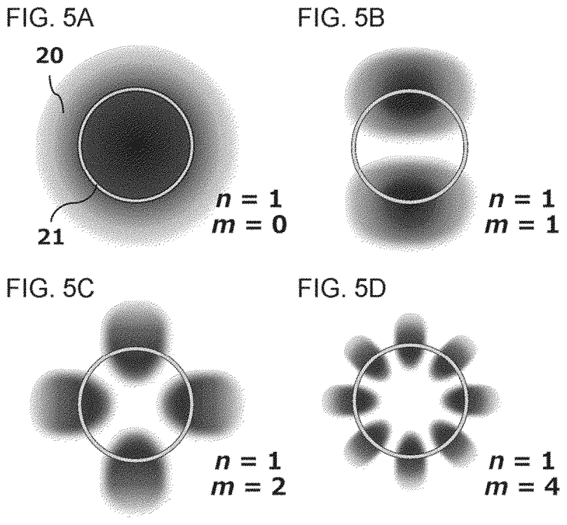

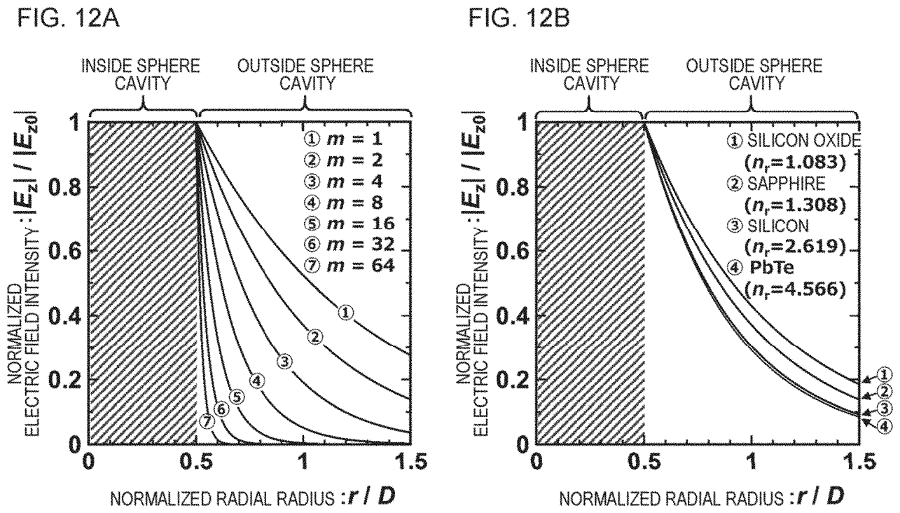

FIGS. 5A to 5D schematically illustrate a distribution of light intensity (|Ez|², Ez: electric field intensity in z-axis direction) in the TE mode formed in a microsphere cavity. Light intensity 20 is represented by shades of gray, and darker shade represents greater intensity. Note that, a reference sign 21 in FIGS. 5A to 5D represent an equator associated with a resonance diameter of the microsphere cavity. A radial mode number is n=1 in all of the light intensity distributions in FIGS. 5A to 5D, and an argument mode number is m=0 in FIG. 5A, m=1 in FIG. 5B, m=2 in FIG. 5C, and m=4 in FIG. 5D. The light intensity distribution is total symmetry, one-fold symmetry, two-fold symmetry, and four-fold symmetry in order from FIG. 5A to FIG. 5D, respectively, according to the argument mode number m, but light intensity is concentrated on the inside of the equator 21 in all of the cases. In a first example embodiment according to the present invention, the WG mode in which the light intensity is concentrated inside the equator is used for vibrational coupling. In this way, aerosol with, as a dispersoid, ultra strong coupling water or a liquid in a vibrational coupling state is generated. On the other hand, when FIGS. 5A to 5D are specifically referred, it is clear that the light intensity is also greatly distributed outside the equator. A degree of the light intensity leaking to the outside of the equator tends to increase with a smaller argument mode number m. This point will be described in detail by a numerical computation in a third example (FIGS. 12A and 12B). In a second example embodiment according to the present invention, the leaking WG mode is used for vibrational coupling. In this way, colloid or emulsion with, as a dispersion medium, ultra strong coupling water or a liquid in a vibrational coupling state is generated.

### [Description of Configuration]

### (Configuration of First Example Embodiment)

Next, a configuration of the first example embodiment of the present invention will be described.

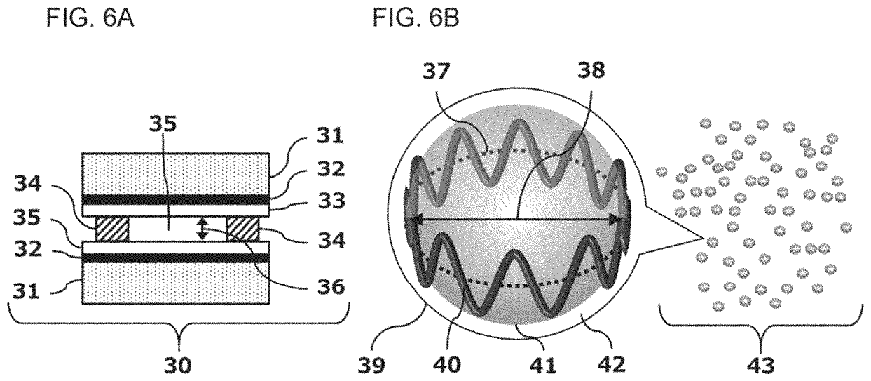

FIGS. 6A and 6B are schematic diagrams representing a difference between a reference technique and the first example embodiment according to the present invention in relation to a method of generating ultra strong coupling water.

In the reference technique illustrated in FIG. 6A, a Fabry-Perot cavity 30 is used for generating ultra strong coupling water. The Fabry-Perot cavity 30 is formed of one set of substrates 31, one set of metal film mirror surfaces 32, one set of protective films 33, and a spacer 34. Note that, the substrate 31 is provided for supporting a case, the metal film mirror surface 32 is provided for forming an optical mode by light confinement, the protective film 33 is provided for preventing the metal film mirror surface 32 and water from direct contact with each other, and the spacer 34 is provided for defining a cavity length 36 and simultaneously preventing leakage of water. In a method of generating ultra strong coupling water by using the Fabry-Perot cavity 30, a frequency ω_{cav} of an optical mode of the Fabry-Perot cavity coincides with a stretching vibrational mode ω₀ of water (ω_{cav}=ω₀) by disposing water 35 inside a space surrounded by the protective films 33 and the spacer 34, and adjusting the cavity length 36, and thus ultra strong coupling water is acquired.

A first problem of the Fabry-Perot cavity 30 is that an extremely small amount of ultra strong coupling water is acquired. For example, in a case where a first optical mode (when ω_{cav}=3400 cm⁻¹, a cavity length is associated with t=1.1.23 μm) of the Fabry-Perot cavity is used in order to resonate with a vibrational mode (ω₀=3400 cm⁻¹) of OH stretching of water, even when the metal film mirror surface 32 has an area of one square meter (1 m²), only ultra strong coupling water of 1.122×10 cm³ (about 0.011 liter) is acquired. To begin with, even when the metal film mirror surface 32 having an area one meter square can be technically prepared, it costs a lot of money. Therefore, it is almost impossible to increase a scale at low cost as long as the Fabry-Perot cavity 30 is used. Further, even when scaling up is attempted by integrating the Fabry-Perot cavity 30, integration is technically difficult and requires an enormous cost. Since this problem is caused by a two-dimensional property of the Fabry-Perot cavity, it is essentially difficult to solve the problem. A second problem is that ultra strong coupling water can be generated only in an extremely limited space such as the inside of the case of the Fabry-Perot cavity 30. In other words, ultra strong coupling water cannot be taken out. The reason is that once ultra strong coupling water is taken out, ultra strong coupling water returns to normal water. Since this problem is caused by an enclosed structure of the Fabry-Perot cavity 30, the problem cannot be also essentially solved. These problems can be solved by using a micro-water sphere cavity according to the present invention exemplified next.

In the first example embodiment according to the present invention illustrated in FIG. 6B, a micro-water sphere cavity 41 is used for generating a liquid in an ultra strong coupling state or a coupling state, e.g., ultra strong coupling water. Herein, a micro-water sphere may be light water (H₂O), heavy water (D₂O), tritiated water (T₂O), or a mixture of at least two or more kinds of light water (H₂O), heavy water (D₂O), and tritiated water (T₂O). In the micro-water sphere cavity 41, water itself floating in a dispersion medium 42 such as air acts as a cavity, and converts itself into ultra strong coupling water. The micro-water sphere cavity 41 is a water sphere being autonomously formed by surface tension, and has a resonance diameter 38 of a micrometer order. A WG mode 40 is formed near an equator 37. When a resonance frequency ω_{cav} of the WG mode 40 formed by the micro-water sphere cavity 41 coincides with a frequency ω₀ of a stretching vibrational mode of water (ω_{cav}=ω₀), the micro-water sphere cavity 41 itself formed of water becomes ultra strong coupling water. When it is considered that an infinite number of equatorial planes where the WG mode 40 is localized is present and a water molecule always has its position fluctuating via a hydrogen bond in general, the entire micro-water sphere cavity 41 can be regarded as uniform ultra strong coupling water by taking a spatial/time average. In other words, aerosol 43 with the micro-water sphere cavity as a dispersoid has a characteristic that the dispersoid is ultra strong coupling water. Herein, aerosol refers to a dispersion system in which a dispersion medium is gas and a dispersoid is liquid, and the word of “aerosol” is used below for a micro-water sphere floating in gas.

A structural characteristic of the micro-water sphere cavity 41 is that the micro-water sphere cavity 41 does not have a component other than water. Therefore, the micro-water sphere cavity 41 does not need one set of substrates 31, one set of metal film mirror surfaces 32, one set of protective films 33, and a spacer 34 like the Fabry-Perot cavity 30 in the reference technique. The reason is that a micro-water sphere itself constitutes a case, total reflection at an interface between a micro-water sphere and a dispersion medium is used for reflection of light, the interface functions as a protective film, and a diameter of a micro-water sphere defines a WG mode. In other words, when the micro-water sphere cavity 41 is used, there is a characteristic that ultra strong coupling water can be extremely easily generated, and a manufacturing cost can be significantly reduced due to an external cavity being unnecessary.

Further, by generating the aerosol 43 with the micro-water sphere cavity as a dispersoid by an existing aerosol generator and the like, manufacturing of ultra strong coupling water can be easily scaled up. For example, even an aerosol generator for an experiment has a capacity of converting 250 liters of water into aerosol per hour. When the present invention being industrially scaled up is applied, a large quantity of ultra strong coupling water can be acquired. In other words, the micro-water sphere cavity 41 has a characteristic that the micro-water sphere cavity 41 can produce ultra strong coupling water in large quantity. Further, since the micro-water sphere cavity 41 does not include an external cavity, ultra strong coupling water can be generated in a macro three-dimensional space. In other words, the micro-water sphere cavity 41 also has a characteristic that the micro-water sphere cavity 41 can freely generate ultra strong coupling water at a desired place when ultra strong coupling water is desired. In addition, as described in a next section, the micro-water sphere cavity 41 also has a characteristic that the micro-water sphere cavity 41 has action of significantly accelerating a chemical reaction since the aerosol 43 according to the present invention is formed of ultra strong coupling water.

To summarize the description above, the following five points are exemplified as characteristics of the first example embodiment according to the present invention:

(1) Aerosol with ultra strong coupling water as a dispersoid is acquired.
(2) A manufacturing cost can be significantly reduced due to absence of a component other than water.
(3) Ultra strong coupling water can be produced in large quantity since scaling up can be easily performed.
(4) When ultra strong coupling water is desired, ultra strong coupling water can be generated at a desired place since water itself is a cavity.
(5) An aerosol is formed of ultra strong coupling water, and thus has extremely high reactivity.

### (Configuration of Second Example Embodiment)

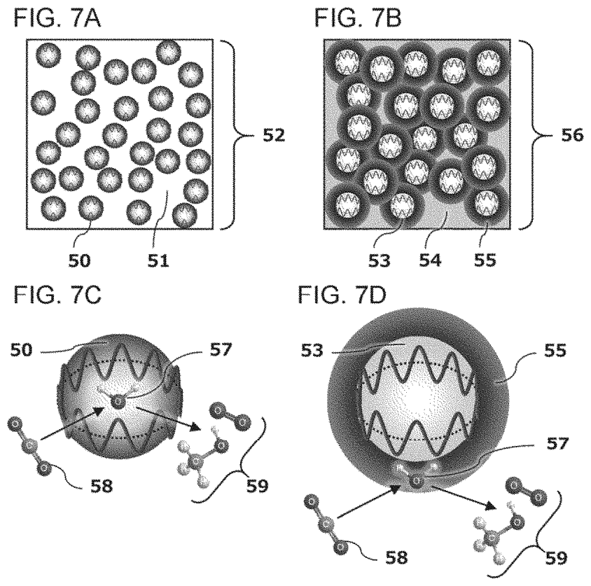

Next, a configuration of the second example embodiment according to the present invention will be described. FIGS. 7B and 7D are schematic diagrams representing the second example embodiment according to the present invention. Note that, for comparison, schematic diagrams representing the first example embodiment according to the present invention are also illustrated in FIGS. 7A and 7C.

FIG. 7A schematically represents aerosol 52 in which a micro-water sphere cavity 50 vibrationally coupled to stretching vibration of water is dispersed in a dispersion medium 51 being gas. Characteristics of the micro-water sphere cavity 50 are as described in the characteristics (1) to (5) in the first example embodiment described above. Note that, FIG. 7A illustrates the aerosol 52 in which all the micro-water sphere cavity 50 has the same resonance diameter, but the aerosol 52 may contain two or more kinds of the micro-water sphere cavity 50 having different resonance diameters, and a function of the aerosol 52 does not theoretically change even when there is a distribution of the resonance diameter.

FIG. 7C is a schematic diagram illustrating a function of an individual micro-water sphere cavity 50 referring to each of the micro-water sphere cavity 50. When a raw material molecule (for example, carbon dioxide) 58 is supplied into the micro-water sphere cavity 50, a water molecule 57 in a vibrational ultra strong coupling state quickly reacts with the raw material molecule 58, and a product molecule (oxygen, methanol) 59 is provided. The high reactivity appears in the entire aerosol 52 formed of the micro-water sphere cavity 50. In other words, the aerosol 52 according to the first example embodiment has a characteristic of high reactivity.

FIG. 7B schematically represents colloid or emulsion 56 in which a micro-dielectric sphere cavity 53 vibrationally coupled to stretching vibration of water is dispersed in water. Herein, the colloid refers to a dispersion system (known also as a gel) in which a dispersion medium is liquid and a dispersoid is solid, and the word of “colloid” is used below when a micro-dielectric sphere is a solid. Meanwhile, the emulsion refers to a dispersion system (known also as a sol) in which a dispersion medium is liquid and a dispersoid is a liquid different from the dispersion medium, and the word of “emulsion” is used below when a micro-dielectric sphere is liquid. In the second example embodiment, by resonantly coupling a WG mode seeping from the micro-dielectric sphere cavity 53 to a vibrational mode of water located around the micro-dielectric sphere cavity 53, an ultra strong coupling water region 55 is formed around the micro-dielectric sphere cavity 53. Note that, FIG. 7B illustrates a case where the micro-dielectric sphere cavity 53 is one kind, but there is no difference in function even when two or more kinds are mixed. Further, even when there is a distribution of a resonance diameter, a function of the colloid or emulsion 52 does not theoretically change.

FIG. 7D is a schematic diagram of a case where an individual micro-dielectric sphere cavity 53 is referred. Herein, a micro-dielectric sphere cavity refers to a cavity that has a resonance diameter D of a micrometer order, generates a WG mode vibrationally coupled to a vibrational mode, and is formed of a dielectric sphere. A condition for a dielectric constituting a micro-dielectric sphere is to have a refractive index greater than a refractive index (1.310, middle infrared region) of water in order to satisfy a total reflection condition, i.e., to have a relative refractive index greater than 1 (nr=n_{cav}/nₑₙᵥ>1, n_{cav}: refractive index inside sphere, nₑₙᵥ: refractive index of environment outside sphere). From a different perspective, a condition required of the micro-dielectric sphere cavity 53 is only two conditions of a structure parameter being a resonance diameter and a macro optical characteristic being a relative refractive index, and has absolutely nothing to do with physical properties such as an elementary composition, an energy level, a band gap, an interface level, a surface potential, and a chemical property. Therefore, as illustrated in a first column of Tables 5 and 6 described later, the micro-dielectric sphere cavity 53 in a second example has a characteristic that a dielectric formed of a variety of liquid and solids can be used. A micro-dielectric sphere can be produced in large quantity by an existing particle manufacturing method and an existing emulsion manufacturing method. Further, water being a dispersoid may be normal water. Therefore, the colloid or emulsion 56 according to the present invention has a characteristic that the colloid or emulsion 56 can be produced in large quantity by a method that enables scaling up.

Herein, the first example embodiment and the second example embodiment according to the present invention are compared by using FIGS. 7A to 7D. There is a characteristic that ultra strong coupling water is generated inside a cavity in the micro-water sphere cavity 50 according to the first example embodiment, whereas the ultra strong coupling water region 55 is formed outside a cavity in the micro-dielectric sphere cavity 53 according to the second example embodiment. Ultra strong coupling water is acquired by using the WG mode leaking from the cavity described in FIGS. 5A to 5D for formation of the ultra strong coupling water region 55, and vibrationally coupling the WG mode to a vibrational mode of water near the cavity. Further, there is a characteristic that the first example embodiment has the configuration in which aerosol includes a dispersion medium being gas and a dispersoid being ultra strong coupling water, whereas the second example embodiment has the configuration in which a dispersion medium is ultra strong coupling water, a dispersoid being a solid dielectric forms colloid, and a dispersoid being a liquid dielectric forms emulsion.

Next, a proportion of the ultra strong coupling water region 55 to the entire dispersion medium is computed. As described in detail in a third example, an electric field region of the WG mode leaking from the micro-dielectric sphere cavity 53 spans across about the resonance diameter D in a radial direction measured from a boundary surface (see FIG. 12A). Note that, a leaking electric field region is spherically symmetrical by taking a spatial/time average. In a case where a leaking electric field region effective for generating ultra strong coupling water spans across D/2 in the radial direction measured from the boundary surface, volume of the ultra strong coupling water region 55 corresponds to seven times volume of the micro-dielectric sphere cavity 53 ({4π(2r)³/3−4πr³/3}/(4πr³/3)=(8−1)/1=7). Therefore, when a volume fraction (volume of dispersoid/volume of dispersion medium) of the colloid or emulsion 56 is f, water being a dispersion medium becomes ultra strong coupling water in the entire region as long as f≥1/7. On the other hand, when f<1/7, the ultra strong coupling water region 55 has a proportion of 7f, and a region 54 of bulk water has a proportion of 1-7f. For example, even when a volume fraction is f=1%, the ultra strong coupling region 55 occupies 7% of the entire dispersion medium. In a similar discussion, when an effective range is D, a volume ratio between the ultra strong coupling water region 55 and the micro-dielectric sphere cavity 53 reaches 26 (27−1=26), and when f≥1/26, ultra strong coupling water is acquired in the entire region, whereas when f<1/26, the ultra strong coupling water region 55 has a proportion of 26f and the region 54 of bulk water has a proportion of 1−26f. In this case, even when f=1%, the ultra strong coupling region 55 spans across 26% of the whole. However, in the discussion described above, it is assumed that there is no overlapping in the leaking electric field region between the individual micro-dielectric sphere cavities 53, a proportion of the ultra strong coupling region 55 is lower than the estimated value described above. However, when it is considered that a water molecule always has its position fluctuating via a hydrogen bond in general, and the ultra strong coupling region 55 can be averaged by stirring the colloid or emulsion 56, even with a low volume fraction f, there is actually no region 54 of bulk water as a spatial/time average, and the entire water being a dispersion medium can be converted into ultra strong coupling water. In other words, the colloid or emulsion 56 has a characteristic that a dispersoid is ultra strong coupling water.

As illustrated in FIG. 7D, the micro-dielectric sphere cavity 53 can be used for accelerating a chemical reaction similarly to the micro-water sphere cavity 50. However, the micro-dielectric sphere cavity 53 itself is not involved in a reaction, and the ultra strong coupling water region 55 formed around the micro-dielectric sphere cavity 53 is responsible for a reaction. When a raw material molecule (carbon dioxide) 58 is supplied to the ultra strong coupling water region 55, a water molecule 57 in a vibrational ultra strong coupling state quickly reacts with the raw material molecule 58, and a product molecule (oxygen, methanol) 59 is provided. The high reactivity appears in the entire colloid 56. In other words, similarly to the aerosol 52 according to the first example embodiment, the colloid 56 according to the second example embodiment also has a characteristic of high reactivity.

In addition, the colloid 56 according to the second example embodiment has a characteristic that the colloid 56 can more easily perform a chemical reaction as compared with the aerosol 52 according to the first example embodiment. In a case of the aerosol 52, water and a raw material are consumed in the micro-water sphere cavity 50 and a product is accumulated as a reaction progresses, and thus a resonance diameter slightly changes. Thus, an additional apparatus for maintaining a resonance condition of vibrational coupling is needed. On the other hand, in a case of the colloid 56, a state of the micro-dielectric sphere cavity 53 does not basically change while a reaction progresses. Therefore, a special additional apparatus is not needed.

As described above, in the reference technique, when ultra strong coupling water or a liquid in a vibrational coupling state is produced, an optical mode needs to be formed by using an external cavity such as a Fabry-Perot cavity, and the optical mode needs to be coupled to a vibrational mode of water or a liquid in a vibrational coupling state. The external cavity limits a space in which a vibrational coupling state of a matter is used, and it also costs money for manufacturing the external cavity. The cost increases in proportion to an apparatus scale, and thus it costs a lot of money particularly when a scale of an apparatus is increased.

In contrast, in the present example embodiment, by using a microsphere cavity that can spontaneously form an optical mode referred to as a whispering gallery mode (abbreviated to a WG mode or a WGM), a method of producing ultra strong coupling water or a liquid in a vibrational coupling state in large quantity at low cost in forms of aerosol, colloid, and emulsion can be provided.

To summarize the description above, the following six points are exemplified as characteristics of the second example embodiment according to the present invention:

(1) Colloid or emulsion with ultra strong coupling water as a dispersion medium is acquired.
(2) A component is only water and a micro-dielectric sphere, and thus a manufacturing cost can be reduced.
(3) Ultra strong coupling water can be produced in large quantity since scaling up can be easily performed.
(4) By only mixing a micro-dielectric sphere cavity into water, ultra strong coupling water can be generated at a desired place when ultra strong coupling water is desired.
(5) A variety of dielectrics can be used for a configuration of a micro-dielectric sphere cavity.
(6) Colloid or emulsion is formed of ultra strong coupling water, and thus has extremely high reactivity.

As a summary of the description of the configuration, a comparison between the first and second example embodiments is described in Table 1 exemplified next.

TABLE 1

| | FIRST EXAMPLE | SECOND EXAMPLE |
|---|---|---|
| | EMBODIMENT | EMBODIMENT |
| CAVITY NAME | MICRO-WATER SPHERE CAVITY | MICRO-DIELECTRIC SPHERE CAVITY |
| DISPERSION | AEROSOL | COLLOID(DESPERSION MEDIUM IS SOLID) |
| SYSTEM | | EMULSION(DISPERSION MEDIUM IS LIQUID) |
| DISPERSION | GAS (SUCH AS AIR) | BULK WATER |
| MEDIUM | | (→ ULTRA STRONG COUPLING WATER) |
| DISPERSOID | MICRO-WATER SPHERE | MICRO-DIELECTRIC SPHERE |
| | (→ULTRA STRONG COUPLING WATER) | |
| OPTICAL MODE | WG MODE GENERATED IN | WO MODE LEAKING TO OUTSIDE |
| | MICRO-WATER SPHERE CAVITY | OF CRO-WATER SPHERECAVITY |
| VIBRATIONAL | STRETCHING VIBRATIONAL MODE | STRETCHING VIBRATIONAL MODE |
| MODE | OF WATER IN MICRO-WATER SPHERE | OF BULK WATER |
| EFFECT | GENERATION OF ULTRA STRONG | GENERATION OF BULK ULTRA |
| | COUPLING WATER AEROSOL | STRONG COUPLING WATER |
| CHARACTERISTIC | (1) AEROSOL WITH ULTRA STRONG | (1) COLLOID OR EMULSION WITH ULTRA |
| | COUPLING WATER AS DISPERSOID | STRONG COUPLING WATER |
| | IS ACQUIRED. | DISPERSION MEDIUM IS ACQUIRED |
| | (2) MANUFACTURING COST CAN BE | (2) COMPONENT IS ONLY WATER AND |
| | SIGNIFICANTLY REDUCED DUE TO | MICRO-DIELECTRIC SPHERE AND |
| | ABSENCE OF COMPONENT OTHER | THUS MANUFACTURING COST CAN |
| | THAN WATER. | BE REDUCED. |
| | (3) ULTRA STRONG COUPLING WATER | (3) ULTRA STRONG COUPLING WATER |
| | CAN BE PRODUCED IN LARGE | CAN BE PRODUCED IN LARGE |
| | QUANTITY SINCE SCALING UP CAN | QUANTITY SINCE SCALING UP CAN |
| | BE EASILY PERFORMED. | BE EASILY PFRPORMED |
| | (4) WHEN ULTRA STRONG COUPLING | (4) BY ONLY MIXING MICRO-DIELECTRIC |
| | WATER IS DESIRED, ULTRA STRONG | SPHERE CAVITY INTO WATER, ULTRA |
| | COUPLING WATER CAN BE | STRONG COUPLING WATER CAN BE |
| | GENERATED AT DESIRED PLACE | GENERATED AT DESIRED PLACE |
| | SINCE WATER ITSELF IS CAVITY | WHEN ULTRA STRONG COUPLING |
| | (5) AEROSOL IS FORMED OF ULTRA | WATER IS DESIRED |
| | STRONG COUPLING WATER, AND | (5) VARIETY OF DIELECTRICS CAN BE |
| | IS THUS HIGHLY REACTIVE | USED FOR FORMING DISPERSION |
| | | SYSTEM. |
| | | (6) COLLOID OR EMULSION IS FORMED |
| | | OF ULTRA STRONG COUPLING |
| | | WATER, AND IS THUS HIGHLY |
| | | REACTIVE. |

### [Description of Implementation Method]

### (Method of Implementing First Example Embodiment)

Next, a method of implementing the first example embodiment according to the present invention will be described. Herein, a chemical reaction system using a characteristic that a micro-water sphere cavity is highly reactive will be described.

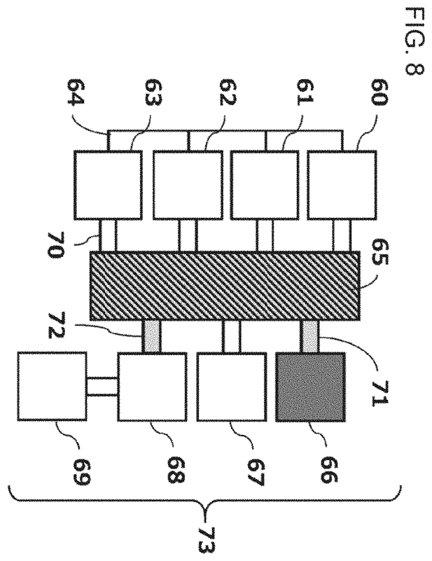

FIG. 8 illustrates a schematic diagram of a chemical reaction system 73 using a micro-water sphere cavity exemplified in the first example embodiment. First, aerosol formed of the micro-water sphere cavity is generated in an aerosol generation apparatus 66 and introduced to a reaction container 65 via an introduction port 71. Simultaneously, a raw material is introduced from a raw material supply apparatus 67 into the reaction container 65 via a pipe 70, and a predetermined chemical reaction is performed. Note that, a raw material may include a matter other than a matter used for a predetermined reaction. Aerosol formed of a micro-water sphere cavity is ultra strong coupling water, and thus has extremely high reactivity, and a raw material taken into the micro-water sphere cavity quickly reacts. Note that, in relation to a raw material supply, a raw material may be previously put in water used in the aerosol generation apparatus 66.

While a predetermined reaction progresses, a resonance diameter of the micro-water sphere cavity in the reaction container 65 is monitored by using a resonance diameter observation apparatus 60, and monitor information thereof is transmitted to a humidification apparatus 61, a heating/cooling apparatus 62, and a decompression/compression apparatus 63 via a control signal cable 64. In this way, by appropriately controlling a parameter of each of the humidification apparatus 61, the heating/cooling apparatus 62, and the decompression/compression apparatus 63 by a control unit of each of the apparatuses, a resonance diameter of the micro-water sphere cavity is controlled to a best value that enables a function as ultra strong coupling water. Note that, the humidification apparatus 61 acts in such a way as to supply water in the micro-water sphere cavity decreasing as a reaction progresses. Further, the heating/cooling apparatus 62 acts in such a way as to adjust a reaction rate, and also control a resonance diameter of the micro-water sphere cavity through a fine adjustment to density of water in the micro-water sphere cavity by a temperature change. Furthermore, the decompression/compression apparatus 63 acts in such a way as to adjust a reaction rate by adjusting pressure in the reaction container 65, and also control a resonance diameter of the micro-water sphere cavity through vaporization/condensation of water in the micro-water sphere cavity. A signal between the control apparatuses of a resonance diameter is performed feedback to each other via the control signal cable 64. In this way, a resonance diameter of the micro-water sphere cavity is precisely controlled.

When the predetermined reaction ends, a reactant is taken into a product separation apparatus 68 from the reaction container 65 via a discharge port 72, and a target product is then separated from water and a by-product. Note that, once the reactant is liquefied, ultra strong coupling water returns to normal water and can thus be safely handled. Finally, the target product is transmitted to and collected by a product collection container 69 via the pipe 70. In this way, a series of steps end.

The chemical reaction system 73 using the micro-water sphere cavity described above has the following six characteristics:

(1) The chemical reaction system 73 can be applied to a wide range of chemical reactions in which water is involved, and can remarkably accelerate a reaction.
(2) Since the micro-water sphere cavity is formed of ultra strong coupling water, the micro-water sphere cavity is originally water regardless of extremely high reactivity, and can thus be safely handled with a sense of security before and after a reaction.
(3) Water being a basis of the micro-water sphere cavity is different from another resource, is omnipresent throughout the earth, and is thus available at extremely low cost anytime anywhere.
(4) Water itself is harmless, is least likely to pollute an environment, and is thus the most eco-friendly.
(5) A function of the microsphere cavity can be maintained even when a scale is reduced/expanded, and thus the chemical reaction system 73 can be scaled up from an apparatus of a mobile size to a large chemical plant.
(6) There is a variety of chemical reactions in which water is involved, and thus the chemical reaction system 73 is useful for a wide range of uses such as manufacturing of useful chemical product and medical product, also soot and smoke treatment, detoxification of toxic gas, removal of NOx from exhaust gas, and purification/sterilization of ambient air.

### (Method of Implementing Second Example Embodiment)

Next, a method of implementing the second example embodiment according to the present invention will be described. Herein, a chemical reaction system using a characteristic that a micro-dielectric sphere cavity is highly reactive will be described.

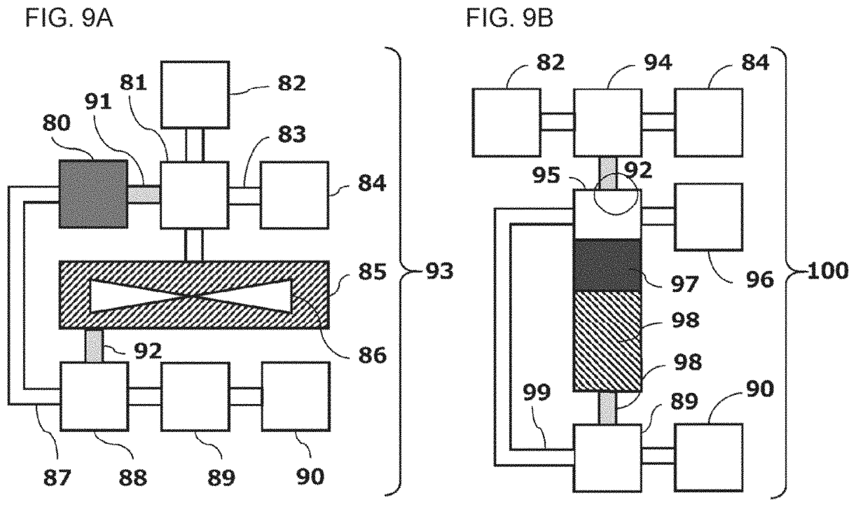

FIGS. 9A and 9B are schematic diagrams of chemical reaction systems using the second example embodiment, FIG. 9A represents a batch-type chemical reaction system 93 using a micro-dielectric sphere cavity in a colloid state or an emulsion state by stirring, and FIG. 9B represents a continuous-type chemical reaction system 100 using colloid constituting a micro-dielectric sphere cavity in a precipitated state or a state carried by a medium. Hereinafter, each of the systems will be described.

First, the batch-type chemical reaction system 93 using the micro-dielectric sphere cavity will be described.

In FIG. 9A, first, the micro-dielectric sphere cavity is introduced from a micro-dielectric sphere supply apparatus 80 into a mixing apparatus 81 via an introduction port 91, and water is introduced from a water supply apparatus 82 into the mixing apparatus 81 via a pipe 83. Note that, the micro-dielectric sphere cavity is prepared in advance, and a stabilizer of the micro-dielectric sphere cavity is added in advance as necessary. In order to prepare the micro-dielectric sphere cavity in advance, for example, the condition exemplified in the example embodiment described above may be satisfied by using an existing method. After colloid or emulsion of the micro-dielectric sphere cavity is adjusted in the mixing apparatus 81, a raw material is supplied from a raw material supply apparatus 84 to the mixing apparatus 81 via the pipe 83. Note that, a raw material may include a matter other than a matter used for a predetermined reaction. Next, the colloid or the emulsion of the micro-dielectric sphere cavity is mixed with the predetermined raw material in the mixing apparatus 81, a reaction mixed liquid is then introduced into a reaction container 85 via the pipe 83, and a predetermined reaction starts.

The reaction mixed liquid is stirred by using a stirrer 86 while the predetermined reaction progresses, and thus ultra strong coupling water is distributed into the entire reaction mixed liquid. Since ultra strong coupling water is extremely highly reactive, the predetermined reaction quickly progresses. Note that, the micro-dielectric sphere cavity itself does not react and is not consumed, and thus apparatuses that control a resonance diameter like the chemical reaction system 73 using the micro-water sphere cavity in FIG. 8 are not needed. However, in order to control a predetermined reaction itself, a heating/cooling apparatus and a compression/decompression apparatus may be attached to the reaction container 85.

After the predetermined reaction ends, a reaction liquid is transmitted from the reaction container 85 to a micro-dielectric sphere separation apparatus 88 via a discharge port 92, and the micro-dielectric sphere cavity is removed from the reaction liquid by using the micro-dielectric sphere separation apparatus 88. When the removed micro-dielectric sphere cavity is a solid, the solid micro-dielectric sphere cavity is transmitted from the micro-dielectric sphere separation apparatus 88 to the micro-dielectric sphere supply apparatus 80 via a micro-dielectric sphere collection pipe 87, and is reused for a next reaction. The solid micro-dielectric sphere cavity is not consumed by a reaction, and can thus be repeatedly reused. Next, a remaining reaction liquid is moved to a product separation apparatus 89 via the pipe 83, and a target product is separated from the remaining reaction liquid by using the product separation apparatus 89. Note that, once the micro-dielectric sphere cavity is removed from the reaction liquid, ultra strong coupling water returns to normal water, and thus the remaining reaction liquid can be safely handled. Finally, the target product is moved to a product collection container 90 via the pipe 83 and is collected, and thus a series of steps end.

The batch-type chemical reaction system 93 using the micro-dielectric sphere cavity described above has the following nine characteristics:

(1) The batch-type chemical reaction system 93 can be applied to a wide range of chemical reactions in which water is involved, and can remarkably accelerate a reaction.
(2) Ultra strong coupling water generated by a micro-dielectric sphere is originally water regardless of high reactivity, and can thus be safely handled with a sense of security before and after a reaction.
(3) Water being a basis of ultra strong coupling water is different from another resource, is omnipresent throughout the earth, and is thus available at extremely low cost anytime anywhere.
(4) Water itself is harmless, is least likely to pollute an environment, and is thus the most eco-friendly.
(5) A function of the microsphere cavity can be maintained even when a scale is reduced/expanded, and thus the batch-type chemical reaction system 93 can be scaled up from an apparatus of a mobile size to a large chemical plant.
(6) Ultra strong coupling water in bulk can be used.
(7) When the micro-dielectric sphere cavity is a solid, the micro-dielectric sphere cavity can be repeatedly reused.
(8) Apparatuses that control a resonance diameter are not needed.
(9) Since there is a variety of chemical reactions in which water is involved, the batch-type chemical reaction system 93 is useful for a wide range of uses in a chemical/pharmaceutical field such as manufacturing of useful chemical product and medical product, also a general industrial field such as liquid-waste/sewage treatment and detoxification of a toxic matter, a daily necessities/health care field such as removal of a trihalomethane from drinking water and sterilization of well water and ground water, and furthermore a biotechnology/medical field such as enzyme synthesis, fermentation, cell culture, purification of blood, removal of a virus, and sterilization.

Next, the continuous-type chemical reaction system 100 using the micro-dielectric sphere cavity will be described.

In FIG. 9B, first, water and a raw material are transmitted from the water supply apparatus 82 and the raw material supply apparatus 84 to a mixing apparatus 94 via the pipe 83, respectively, and are mixed by using the mixing apparatus 94. Note that, a raw material may include a matter other than a matter used for a predetermined reaction. Next, the mixed liquid is introduced into a reaction column 95 via an introduction port 92, and is transmitted through a filler 98 formed of a micro-dielectric sphere cavity. At this time, water in the mixed liquid is converted into ultra strong coupling water by action of the micro-dielectric sphere cavity. Since ultra strong coupling water is extremely highly reactive, the predetermined reaction quickly progresses.

Note that, the micro-dielectric sphere cavity 98 filling in the column may include colloid formed of the micro-dielectric sphere cavity carried in fiber and the like, or may include colloid formed of the micro-dielectric sphere cavity being precipitated. The carrying-type in the former case has an advantage in which outflow of a mixed liquid is smooth since a distance between micro-dielectric sphere cavities can be adjusted by a carrier. Therefore, the carrying-type is suitable to a case where a mixed liquid easily causes clogging, for example, a case where a resonance diameter of a micro-dielectric sphere cavity is extremely small, which is equal to or less than few μm. Meanwhile, the precipitation-type in the latter case has an advantage in which water in a mixed liquid can be almost completely converted into ultra strong coupling water since individual micro-dielectric sphere cavities are located close to each other. Therefore, the precipitation-type is suitable to a case where clogging with a mixed liquid does not need to be taken into consideration, for example, a case where a resonance diameter of a micro-dielectric sphere cavity is relatively large. In either case, a compression apparatus 96 may be installed to increase pressure inside the reaction column 95, and outflow of a mixed liquid 97 may thus be accelerated. Note that, the micro-dielectric sphere cavity itself does not react and is not consumed, and thus apparatuses that control a resonance diameter like the chemical reaction system 73 using the micro-water sphere cavity in FIG. 8 are not needed. However, in order to control a predetermined reaction itself, a heating/cooling apparatus and a compression/decompression apparatus may be attached to the reaction column 95.

After the predetermined reaction ends, a reaction liquid is transferred from the reaction column 95 to the product separation apparatus 89 via a discharge port 98. At this time, the reaction liquid is returned to the reaction column 95 by using a loop pipe 99, and thus the same reaction may be repeated. Note that, water in the reaction liquid returns from ultra strong coupling water to normal water at a moment when the reaction liquid exits from the reaction column 95, and thus the reaction liquid can be safely handled. Next, a target product is separated from the reaction liquid by using the product separation apparatus 89. Finally, the target product is moved to the product collection container 90 via the pipe 83 and is collected, and thus a series of steps end. Note that, in the continuous-type chemical reaction system 100 using the micro-dielectric sphere cavity, a step of mixing/separating water and the micro-dielectric sphere cavity is not needed before and after a reaction. Therefore, the present system can be extended to a multistage reaction system. For example, a version of the present system can be upgraded to a multistage reaction system by coupling, in series, a reaction column 95 group associated with each step of a multistage reaction. Further, the introduction port 92 and the discharge port 98 of the reaction column 95 conform to JIS standards and the like and are packaged, and thus the present system can also be incorporated as a reaction column/unit into various chemical plants, and an existing continuous-type system such as a tap water/sewage treatment system and an artificial liver system.

The continuous-type chemical reaction system 100 using the micro-dielectric sphere cavity described above has the following 12 characteristics:

(1) The continuous-type chemical reaction system 100 can be applied to a wide range of chemical reactions in which water is involved, and can remarkably accelerate a reaction.
(2) Ultra strong coupling water generated by a micro-dielectric sphere is originally water regardless of high reactivity, and can thus be safely handled with a sense of security before and after a reaction.
(3) Water being a basis of ultra strong coupling water is different from another resource, is omnipresent throughout the earth, and is thus available at extremely low cost anytime anywhere.
(4) Water itself is harmless, is least likely to pollute an environment, and is thus the most eco-friendly.
(5) A function of the microsphere cavity can be maintained even when a scale is reduced/expanded, and thus the continuous-type chemical reaction system 100 can be scaled up from an apparatus of a mobile size to a large chemical plant.
(6) Ultra strong coupling water in bulk can be used.
(7) Since the micro-dielectric sphere cavity is a solid, the micro-dielectric sphere cavity can be repeatedly reused.
(8) Apparatuses that control a resonance diameter are not needed.
(9) The micro-dielectric sphere cavity is used to fill in the column, and thus a step of mixing/separating water and the micro-dielectric sphere cavity is not needed before and after a reaction.
(10) The continuous-type chemical reaction system 100 can be easily extended to a multistage reaction system.
(11) The continuous-type chemical reaction system 100 can be incorporated into an existing continuous-type system.
(12) Since there is a variety of chemical reactions in which water is involved, the continuous-type chemical reaction system 100 is useful for a wide range of uses in a chemical/pharmaceutical field such as manufacturing of useful chemical product and medical product, also a general industrial field such as liquid-waste/sewage treatment and detoxification of a toxic matter, a daily necessities/health care field such as removal of a trihalomethane from drinking water and sterilization of well water and ground water, and furthermore a biotechnology/medical field such as enzyme synthesis, fermentation, cell culture, purification of blood, removal of a virus, and sterilization.

### Other Example Embodiment of Invention

As described above, a combination of water and a microsphere cavity is described as the best form for implementing the invention and an example thereof. The principle thereof is that, by vibrationally coupling a stretching vibrational mode of water to a WG mode being an optical mode formed by a microsphere cavity, water in a vibrational ultra strong coupling state, i.e., ultra strong coupling water is acquired as a form of aerosol, colloid, and emulsion. However, in terms of the principle of the present invention, a liquid combined with a microsphere cavity is not limited to water. The reason is that a liquid other than water always has some sort of molecular structure, and thus some sort of molecular vibration is always performed. Thus, according to the present invention, even with a liquid other than water, by vibrationally coupling a vibrational mode of the liquid to a WG mode of a microsphere cavity, a liquid in a vibrational coupling state can be acquired as a form of aerosol, colloid, and emulsion. Hereinafter, it is demonstrated that the description above can be actually achieved.

A point to be paid attention to when a liquid other than water is used is that a ratio n_{cav}/nₑₙᵥ of a refractive index between inside and outside of a cavity needs to be considered since total reflection in the cavity is a necessary condition in order for a microsphere cavity to form a WG mode. As described above, the total reflection condition of the WG mode in the microsphere cavity is n_{cav}/nₑₙᵥ>1.

In a case of aerosol, a refractive index of a gas being a dispersion medium is as close to 1 as possible, and thus the condition of n_{cav}/nₑₙᵥ>1 can be achieved in all liquids. On the other hand, in a case of colloid and emulsion, a general liquid has a refractive index of about 1.4±0.1, which is about the same as water (1.310). Further, with reference to the first column in Tables 5 and 6, most of dielectrics have a sufficiently great refractive index, and thus n_{cav}/nₑₙᵥ>1 can be sufficiently achieved.

Therefore, the discussion about a combination of water and a microsphere cavity described above can be used for a discussion about a combination of a liquid other than water and a microsphere cavity. Thus, a conclusion is drawn for most of liquids that a liquid in a vibrational coupling state can be manufactured as aerosol, colloid, and emulsion.

A liquid used as other example embodiment according to the present invention is as illustrated in next Table 2. Note that, a result of a numerical computation for some specific examples will be exemplified in a fifth example.

TABLE 2

| | | KIND OF | KIND OF | |
|---|---|---|---|---|
| | | SOLVENT OR | SOLUTE | |
| | KIND OF | DISPERSION | OR | |
| | LIQUID | MEDIUM | DISPERSOID | SPECIFIC EXAMPLE |
| I | AQUEOUS | WATER | INORGANIC SALT, | SALINE SOLUTION (NaCl) |
| | SOLUTION | | INORGANIC ACID, | DILUTE SULFURIC ACID (H₂SO₄), |
| | | | PEROXIDE, | HYDROGEN PEROXIDE SOLUTION |
| | | | ORGANIC MATTER, | (H₂O₂), FORMALIN (HCHO), |
| | | | ORGANISM- | GLUCOSE AQUEOUS SOLUTION |
| | | | RELATED MATTER, | (C₆H₁₂O₆), |
| | | | AND THE LIKE | ATP (ADENOSONE TRI-PHOSPHATE) |
| | | | | AQUEOUS SOLUTION, |
| | | | | AND THE LIKE |
| II | ORGANIC | ORGANIC | NONE | METHANOL (CH₃OH), |
| | LIQUID | SOLVENT: | | ACETONE ((CH₃)₂CO), |
| | | ALCOHOL, | | ACETIC ACID (CH₃COOH), |
| | | ALDEHYDE | | BENZENE (C₆H₆), |
| | | KETONE, | | HEXANE (C₆H₁₄), |
| | | CARBOXYLIC ACID, | | CHLOROFORM (CHCl₃), |
| | | HYDROCARBON, | | AND THE LIKE |
| | | HALOCARBON, AND | INORGANIC MATTER, | COMBINATION OF SOLUTE |
| | | THE LIKE | ORGANIC MATTER, | DESCRIBED ON LEFT AND |
| | | | AND THE LIKE | SOLVENT DESCRIBED ABOVE |
| III | INORGANIC | INORGANIC | NONE | CARBON DISULFIDE (CS₂), |
| | LIQUID | SOLVENT: | | HYDROFLUORIC ACID (HF), |
| | | SULFIDE | | ANTIMONY PENTAFLUORIDE |
| | | HYDROGEN HALIDE, | | (SbF₅), |
| | | PERHALIDE, AND | | BROMINE, PENTAFLUORIDE (BrF₅), |
| | | THE LIKE | | IODINE PENTAFLUORIDE (IF₅), |
| | | | | AND THE LIKE |
| | | | INORGANIC MATTER, | COMBINATION OF SOLUTE |
| | | | ORGANIC MATTER, | DESCRIBED ON LEFT AND |
| | | | AND THE LIKE | SOLVENT DESCRIBED ABOVE |
| IV | IONIC LIQUID | LOW-MELTING | NONE | 1-BUTYL-3-METHYLIMIDAZOLIUM |
| | | MOLTEN SALT: | | HEXAFLUOROPHOSPHATE, |
| | | IMIDAZOLIUM- | | ETHYLAMMONIUM NITRITE |
| | | BASED, | | (C₂H₅NH₃NO₃), AND THE LIKE |
| | | PYRIDINIUM-BASED, | INORGANIC MATTER, | COMBINATION OF SOLUTE |
| | | PYRROLIDINIUM- | ORGANIC MATTER, | DESCRIBED ON LEFT AND |
| | | BASED, | AND THE LIKE | SOLVENT DESCRIBED ABOVE |
| | | AMMONIUM-BASED | | |
| | | AND THE LIKE | | |
| V | MIXED LIQUID | WATER, AND | PROTEIN, AMINO | BLOOD, BLOOD PLASMA, LYMPH |
| | SUCH AS | THE LIKE | ACID, SACCHARIDE, | INTERSTITIAL FLUID, URINE |
| | ORGANISM | | FATTY ACID, DNA, | TEAR, SPERM, CULTURE FLUID, |
| | | | RNA, ATP, | CELL DISRUPTION FLUID, |
| | | | COENZYME, | AND THE LIKE |
| | | | HORMONE, | |
| | | | NEURO- | |
| | | | TRANSMITTER, | |
| | | | ELECTROLYTE, | |
| | | | CELL, | |
| | | | CELL ORGANELLE, | |
| | | | BACTERIUM VIRUS, | |
| | | | AND THE LIKE | |

### Characteristic of Other Example Embodiment

To summarize a characteristic of the other example embodiment, based on Table 2, the following eight points are exemplified:

(1) Aerosol with, as a dispersoid, a variety of liquids in a vibrational coupling state is acquired.
(2) Colloid or emulsion with, as a dispersion medium, a variety of liquids in a vibrational coupling state is acquired.
(3) In a case of (1) described above, a component is only liquid, and thus a manufacturing cost can be significantly reduced.
(4) In a case of (2) described above, a component is only liquid and a micro-dielectric sphere, and thus a manufacturing cost can be reduced.
(5) A liquid in a vibrational coupling state can be produced in large quantity since scaling up can be easily performed.
(6) When a liquid in a vibrational coupling state is desired, the liquid in the vibrational coupling state can be freely generated at a desired place.
(7) A liquid in a vibrational coupling state is used for a configuration, and thus it is useful for accelerating a reaction.
(8) As illustrated in V in Table 6, a contribution can be made to biotechnology and a medical field by a method that cannot be achieved by the reference technique, such as detoxification, removal of a virus, and acceleration of cell culture.

### First Example

In a first example, a resonance diameter needed for generating ultra strong coupling water will be described in relation to a micro-water sphere floating in the air.

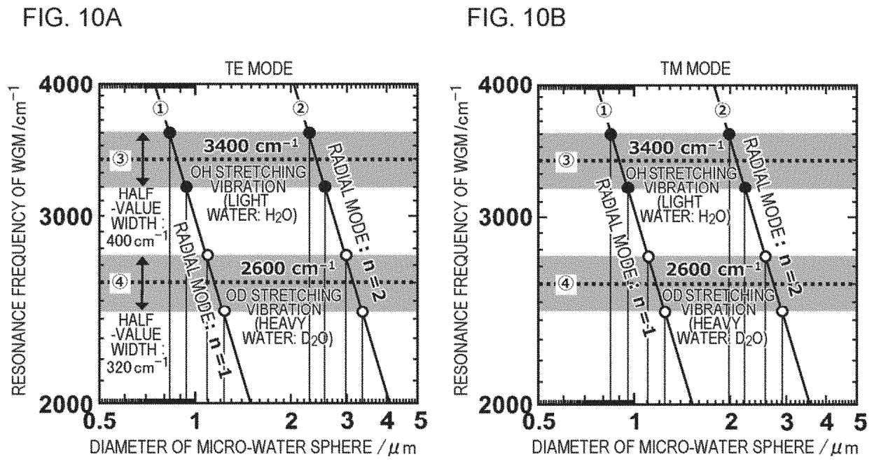

With reference to FIGS. 10A and 10B, a relationship between a resonance frequency and a diameter when a radial mode number is n=1 and 2 and an argument mode number is each m=1 is represented in relation to a micro-water sphere floating in the air. FIG. 10A illustrates a case of a TE mode, and FIG. 10B illustrates a case of a TM mode, where a solid line 1 corresponds to n=1, a solid line 2 corresponds to n=2, a broken line 3 corresponds to a frequency ω₀=3400 cm⁻¹ of an OH stretching vibrational mode of light water (H₂O), a broken line 4 corresponds to a frequency ω₀=2500 cm⁻¹ of an OD stretching vibrational mode of heavy water (D₂O). A hatched portion near the broken line 3 is a region corresponding to a half-value width of 400 cm⁻¹ of the OH stretching vibrational mode of light water (H₂O), and a hatched portion near the broken line 4 is a region corresponding to a half-value width of 320 cm⁻¹ of the OD stretching vibrational mode of heavy water (D₂O). A numerical computation was performed based on the equations (4) to (8), assuming that a refractive index of water having a wavelength near 3 to 4 μm in a middle infrared region (corresponding to a wave number of 3400 cm⁻¹ to 2500 cm⁻¹) is n_{cav}=1.310, and a refractive index of air is nₑₙᵥ=1.0003. Note that, the acquired relationship between a resonance frequency and a diameter of a micro-water sphere was indicated by a log-log plot. A numerical value illustrated in FIGS. 10A and 10B was summarized in Table 3 illustrated next. Table 3 indicates a resonance diameter of a micro-water sphere cavity used for generating ultra strong coupling water.

TABLE 3

| | | RESONANCE DAMETER | | | |
|---|---|---|---|---|---|
| | | (PERMISSIBLE RANGE) | | | |
| | | RADIAL MODE NUMBER: n =1 | | RADIAL MODE NUMBER: n = 2 | |
| | | ARGUMENT MODE NUMBER: m =1 | | ARGUMENT MODE NUMBER: m =1 | |
| | | TE MODE | TM MODE | TE MODE | TM MODE |
| LIGHT | PERFECT MATCH | 0.8772 | 0.8978 | 2.404 | 2.094 |
| WATER | 3400 cm⁻¹ | | | | |
| (H₂O) | MATCH IN | 0.8802 ± 0.0517 | 0.9009 ± 0.0530 | 2.412 ± 0.1418 | 2.101 ± 0.1236 |
| | HALF-VALUE | (±5.9%) | (±5.9%) | (±5.9%) | (±5.9%) |
| | WIDTH | | | | |
| | 3400 ± 200 cm⁻¹ | | | | |
| HEAVY | PERFECT MATCH | 1.193 | 1.221 | 3.269 | 2.848 |
| WATER | 2500 cm⁻¹ | | | | |
| (D₂O) | MATCH IN | 1.198 ± 0.0767 | 1.226 ± 0.0785 | 3.282 ± 0.2100 | 2.860 ± 0.1830 |
| | HALF-VALUE | (±6.4%) | (±6.4%) | (±6.4%) | (±6.4%) |
| | WIDTH | | | | |
| | 2500 ± 160 cm⁻¹ | | | | |

Hereinafter, knowledge acquired from FIGS. 10A and 10B and Table 3 will be described with four points exemplified below.

First, description is given that water has a particularly wide permissible range of a resonance diameter. In FIGS. 10A and 10B, when a micro-water sphere has any diameter on the solid lines 1 and 2, the micro-water sphere acts as a cavity, and a WG mode of each of cases where n=1 and 2 (m=1) is formed in the micro-water sphere cavity. In other words, any diameter on the solid lines 1 and 2 corresponds to a resonance diameter. Next, when the micro-water sphere cavity has a diameter determined from an intersection point of the solid lines 1 and 2 and the broken lines 3 and 4, a WG mode of the micro-water sphere cavity and a stretching vibrational mode of water are vibrationally coupled to each other, and as a result, the micro-water sphere is converted into ultra strong coupling water. In other words, a resonance diameter of the micro-water sphere cavity formed of ultra strong coupling water is uniquely determined. A specific numerical value of the resonance diameter is indicated in a row of “perfect match” in Table 3. Meanwhile, in a range of a half-value width of a stretching vibrational mode of water, vibrational coupling to a WG mode of a micro-water sphere cavity can be achieved, and ultra strong coupling water can be generated. Therefore, a resonance diameter of the micro-water sphere cavity formed of ultra strong coupling water is not determined by one point, and has a range of a half-value width. This range is indicated by intersection lines of the solid lines 1 and 2 and the hatched portions 3 and 4 (a line segment between black dots for light water and a line segment between white dots for heavy water). Further, a specific numerical value in a range of the resonance diameter is indicated in a row of “match in half-value width” in Table 3. Herein, a point to be paid attention to is that an absorption band of stretching vibration of water is extremely broad, and has a half-value width of a highest level among matters. Thus, a range of a resonance diameter in which ultra strong coupling water can be generated is extremely broad. In fact, with reference to Table 3, a permissible range of a resonance diameter is ±5.9% in a case of a micro-water sphere cavity of light water, and is ±6.4% in a case of a micro-water sphere cavity of heavy water, which is extremely broad. Since a geometric standard deviation of a particle size distribution is equal to or less than 1.10 in a general aerosol generator, the permissible range described above can be sufficiently achieved by an existing technique. Therefore, there is a characteristic that water is special for a point that precise diameter control is not needed, and a micro-water sphere cavity can be easily manufactured. Even in a case of a micro-dielectric sphere cavity, the same discussion holds true with water being a dispersion medium.

Secondly, a difference in resonance diameter needed for generating ultra strong coupling water between n=1 and n=2 of a radial mode number will be described. In comparison between n=1 and n=2, a resonance diameter is greater when n=2 than when n=1 in all of cases of light water, heavy water, a TE mode, and a TM mode. The reason is that a radial mode number is a mode number related to an order in a radial direction, and resonance magnitude increases as a radial mode number increases. In fact, in the equation (4), a contribution of the Airy function in the equation (7) is greater when n=2 than when n=1. According to a detailed analysis, by a cut at an equatorial plane, light intensity of a WG mode is distributed in a concentric single ring shape when n=1, and is distributed as a concentric double ring shape when n=2, and the light intensity tends to be greater in an inner ring than an outer ring. In any case, efficiency for generating ultra strong coupling water does not change even when any radial mode number is used, and thus either n=1 or n=2 may be used for generating ultra strong coupling water.

Thirdly, a difference in resonance diameter needed for generating ultra strong coupling water between kinds of polarization and between a TE mode and a TM mode will be described. In general, a resonance diameter of the TE mode is smaller than a resonance diameter of the TM mode. This is caused by a total reflection condition (nᵣ=n_{cav}/nₑₙᵥ>1) for forming a WG mode. The reason is that the TE mode always resonates at a shorter wavelength than the TM mode with the same mode number, and thus the TE mode accordingly always has a smaller resonance diameter than that of the TM mode. However, there is an exception, and when a radial mode number n is n=2 and an argument mode number m is m<2, the size of the resonance diameter is reversed in the TE mode and the TM mode, and the TE mode has a greater resonance diameter than that of the TM mode. In any case, a capacity for generating ultra strong coupling water does not change, and thus either the TE mode or the TM mode may be used for generating ultra strong coupling water.

Fourthly, a difference in resonance diameter needed for generating ultra strong coupling water between light water and heavy water will be described. In any cases of n=1, n=2, the TE mode, and the TM mode, a resonance diameter is smaller when heavy water is used than when light water is used. The reason is simply that the frequency ω₀=3400 cm⁻¹ of the OH stretching vibrational mode of light water is greater than the frequency ω₀=2500 cm⁻¹ of the OD stretching vibrational mode of heavy water. In other words, in terms of a wavelength, a wavelength of a stretching vibrational mode of heavy water is longer than a wavelength of a stretching vibrational mode of light water. With reference to the equation (3), with the same mode number, a resonance diameter is greater when heavy water is used than when light water is used. In any case, a coupling ratio Ω_{R}/2ω₀ of ultra strong coupling water rarely changes when light water or heavy water is used, and thus any of light water, heavy water, and a mixed liquid thereof may be used for generating ultra strong coupling water.

As described above, the first example exemplified that a micro-water sphere of light water and heavy water acts as a cavity, and specifically exemplified a resonance diameter needed for generating ultra strong coupling water. Particularly, it is clarified that, due to an absorption band of stretching vibration of water being extremely broad, a resonance diameter of a micro-water sphere cavity needed for generating ultra strong coupling water falls within a range of around about 6% of a value of a perfect match.

### Second Example

In a second example, how a resonance diameter needed for generating ultra strong coupling water depends on kinds (light water and heavy water) of water, kinds (TE mode and TM mode) of deflection, a radial mode number n, and an argument mode number m will be described in relation to a micro-water sphere floating in the air.

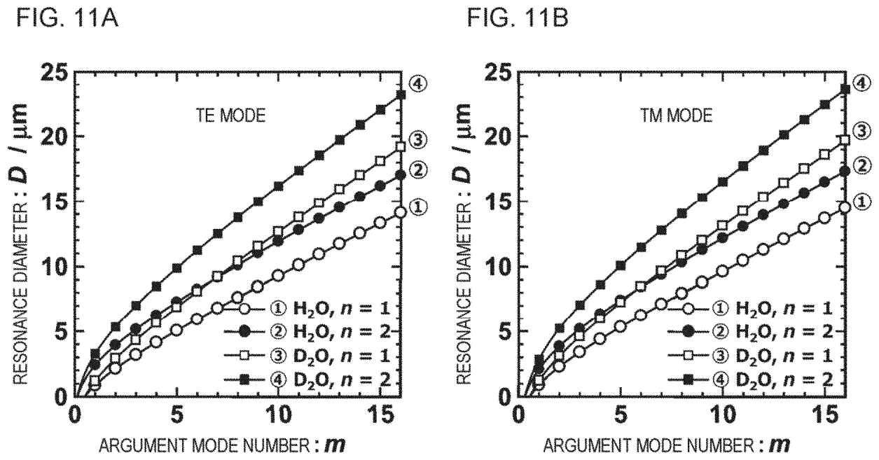

With reference to FIGS. 11A and 11B, dependence, on a radial mode number and an argument mode number, of a resonance diameter in which a micro-water sphere cavity floating in the air is converted into ultra strong coupling water is represented. A vertical axis is a resonance diameter D, and a horizontal axis is an argument mode number m. FIG. 11A illustrates a case of the TE mode, and FIG. 11B illustrates a case of the TM mode. In both of FIGS. 11A and 11B, curved lines 1 and 2 indicate a case where light water (H₂O) is used, the curved line 1 corresponds to a case where a radial mode number is n=1, and the curved line 2 corresponds to a case where a radial mode number is n=2, and curved lines 3 and 4 indicate a case where heavy water (D₂O) is used, the curved line 3 corresponds to a case where a radial mode number is n=1, and the curved line 4 corresponds to a case where a radial mode number is n=2. Similarly to the first example, the dependence was numerically computed based on the equations (4) to (8). Note that, following values were used as physical property values necessary for a computation: a refractive index of water of n_{cav}=1.310 (associated with a wavelength near 3 to 4 μm in a middle infrared region and a wave number 3400 cm⁻¹ to 2500 cm⁻¹), a refractive index of air of nₑₙᵥ=1.0001 (associated with a wavelength near 3 to 4 μm in a middle infrared region and a wave number 3400 cm⁻¹ to 2500 cm⁻¹), a frequency ω₀=3400 cm⁻¹ of an OH stretching vibrational mode of light water (H₂O), and a frequency ω₀=2500 cm⁻¹ of an OD stretching vibrational mode of heavy water (D₂O). A numerical value illustrated in FIGS. 11A and 11B was summarized in Table 4 illustrated next. Table 4 illustrates dependence, on a radial mode number and an argument mode number, of a resonance diameter of a micro-water sphere cavity needed for generating ultra strong coupling water.

TABLE 4

| | | RESONANCE DIAMETER [μm] | | | |
|---|---|---|---|---|---|
| RADIAL | ARGUMENT | LIGHT WATER (H₂O) | | HEAVY WATER(D₂O) | |
| MODE | MODE | ω₀ = 3400 cm⁻¹ | | ω₀ = 2500 cm⁻¹ | |
| NUMBER: n | NUMBER m | TE MODE | TM MODE | TE MODE | TM MODE |
| 1 | 1 | 0.8772 | 0.8978 | 1.193 | 1.221 |
| | 2 | 2.134 | 2.282 | 2.902 | 3.103 |
| | 3 | 3.183 | 3.394 | 4.329 | 4.616 |
| | 4 | 4.145 | 4.394 | 5.637 | 5.976 |
| | 5 | 5.057 | 5.333 | 6.876 | 7.253 |
| | 6 | 5.939 | 6.234 | 8.077 | 8.479 |
| | 7 | 6.799 | 7.109 | 9.246 | 9.669 |
| | 8 | 7.643 | 7.966 | 10.394 | 10.833 |
| | 9 | 8.475 | 8.807 | 11.526 | 11.978 |
| | 10 | 9.297 | 9.638 | 12.644 | 13.108 |
| | 11 | 10.111 | 10.459 | 13.751 | 14.224 |
| | 12 | 10.918 | 11.273 | 14.849 | 15.331 |
| | 13 | 11.720 | 12.080 | 15.939 | 16.429 |
| | 14 | 12.517 | 12.892 | 17.023 | 17.519 |
| | 15 | 13.310 | 13.678 | 18.101 | 18.603 |
| | 16 | 14.099 | 14.471 | 19.174 | 19.681 |
| 2 | 1 | 2.404 | 2.094 | 3.269 | 2.848 |
| | 2 | 3.934 | 3.847 | 5.350 | 5.232 |
| | 3 | 5.158 | 5.182 | 7.015 | 7.047 |
| | 4 | 6.253 | 6.344 | 8.504 | 8.628 |
| | 5 | 7.276 | 7.413 | 9.895 | 10.082 |
| | 6 | 8.253 | 8.424 | 11.224 | 11.457 |
| | 7 | 9.197 | 9.395 | 12.508 | 12.777 |
| | 8 | 10.118 | 10.337 | 13.761 | 14.059 |
| | 9 | 11.020 | 11.257 | 14.988 | 15.309 |
| | 10 | 11.908 | 12.159 | 16.195 | 16.536 |
| | 11 | 12.783 | 13.047 | 17.385 | 17.744 |
| | 12 | 13.649 | 13.923 | 18.562 | 18.935 |
| | 13 | 14.505 | 14.789 | 19.727 | 20.112 |
| | 14 | 15.354 | 15.646 | 20.882 | 21.278 |
| | 15 | 16.196 | 16.496 | 22.027 | 22.434 |
| | 16 | 17.033 | 17.339 | 23.165 | 23.581 |

Hereinafter, knowledge acquired from FIGS. 11A and 11B and Table 4 will be described with six points exemplified below.

First, dependence of a resonance diameter needed for generating ultra strong coupling water on a deflection mode number m. With reference to FIGS. 11A and 11B, in any cases of a TE mode, a TM mode, n=1, n=2, light water, and heavy water, a resonance diameter D needed for generating ultra strong coupling water increases as the argument mode number m increases. This tendency can be physically understood with reference to the equation (3) being an approximation equation. In other words, according to the equation (3), when it is considered that a resonating wavelength (10⁴/(n_{cav}·ω₀)) is fixed, the resonance diameter D is proportional (D∝m) to the argument mode number m. In fact, when m>3 in FIGS. 11A and 11B in which a computation was more strictly performed based on the equations (4) to (8), a relationship of D∝m is seen. The reason why a smaller resonance diameter than expected in the relationship of D∝m is acquired in m<3 is that the number of times where light having a wavelength of 10⁴/(n_{cav}·ω₀) is totally reflected by a micro-water sphere cavity interface is small with a small argument mode number, and thus an actual circling distance becomes shorter than a length of an equator. In any case, efficiency for generating ultra strong coupling water does not depend on an argument mode number, and thus any argument mode number may be used for generating ultra strong coupling water.

Secondly, dependence of a resonance diameter needed for generating ultra strong coupling water on polarization will be described. With reference to FIGS. 11A and 11B, in any case of n=1, n=2, light water, and heavy water, a resonance diameter of the TE mode is smaller than a resonance diameter of the TM mode. As described above, this is caused by a total reflection condition (nᵣ=n_{cav}/nₑₙᵥ>1) for forming a WG mode. The reason is that the TE mode always resonates at a shorter wavelength than the TM mode with the same mode number, and thus the TE mode accordingly always has a smaller resonance diameter than that of the TM mode. However, there is an exception, and when a radial mode number n is n=2 and an argument mode number m is m≤2, the size of the resonance diameter is reversed in the TE mode and the TM mode, and the TE mode has a greater resonance diameter than that of the TM mode. In any case, a capacity for generating ultra strong coupling water does not change, and thus either the TE mode or the TM mode may be used for generating ultra strong coupling water.

Thirdly, a permissible range of a resonance diameter needed for generating ultra strong coupling water will be described. FIGS. 11A and 11B and Table 4 illustrate only “perfect match” related to a resonance diameter, and do not illustrate “match in half-value width” as exemplified in the first example. The reason is to avoid complicatedness of the diagrams. In fact, there is also a permissible range of a resonance diameter in the present example, which is the same as the first example. In other words, a permissible range of a resonance diameter is ±5.9% in a case of light water, and is ±6.4% in a case of heavy water.

Fourthly, with reference to Table 4, in any case of light water, heavy water, a TE mode, and a TM mode, in comparison between two resonance diameters with a difference of m being 1 when an argument mode number is m=8 in a case where a radial mode number is n=1 and when m=6 in a case where n=2, a difference between the two resonance diameters is equal to or less than 12% of a resonance diameter. In other words, when m is continuous near a condition described above, permissible ranges of resonance diameters of “match in half-value width” overlap each other. Furthermore, when m=15 in a case where n=1 and when m=13 in a case where n=2, a difference is equal to or less than 6% of a resonance diameter, and permissible ranges of resonance diameters between continuous m almost completely overlap each other. Therefore, when a micro-water sphere cavity has a WG mode that satisfies a condition of m≥8 in a case where n=1 and m≥6 in a case where n=2, all micro-water sphere cavities can be converted into ultra strong coupling water even with a diameter distribution in the micro-water sphere cavity. In other words, under the condition described above, even with a variation in a diameter, all water constituting aerosol becomes ultra strong coupling water. Note that, the micro-dielectric sphere cavity has the same permissible range of a resonance diameter as that described above, and thus the same discussion holds true for generation of ultra strong coupling water by the micro-dielectric sphere cavity.

Fifthly, the reason why a resonance diameter needed for generating ultra strong coupling water is greater when a radial mode number n=2 than when n=1 is as described in the first example. To simply state a reason, the reason is that, in the equation (4), a contribution of the Airy function in the equation (7) is greater when n=2 than when n=1. In any case, efficiency for generating ultra strong coupling water does not change even when any radial mode number is used, and thus either n=1 or n=2 may be used for generating ultra strong coupling water.

Sixthly, the reason why a resonance diameter needed for generating ultra strong coupling water is smaller for light water than heavy water is as described in the first example. To simply state a reason, the reason is that a wavelength of a WG mode is longer in a stretching vibrational mode of heavy water than in a stretching vibrational mode of light water. In any case, a coupling ratio Ω_{R}/2ω₀ of ultra strong coupling water rarely changes when light water or heavy water is used, and thus any of light water, heavy water, and a mixed liquid thereof may be used for generating ultra strong coupling water.

As described above, the second example clarified dependence, on kinds of water, kinds of deflection, a radial mode number n, and an argument mode number m, of a resonance diameter of a micro-water sphere cavity needed for generating ultra strong coupling water. Further, a necessary value for a resonance diameter was determined as a specific numerical value. Furthermore, under the condition that m≥8 in a case where n=1 and m≥6 in a case where n=2, it was exemplified that, even with a variation in a diameter, all water constituting aerosol can be converted into ultra strong coupling water.

### Third Example

A third example describes, when a micro-dielectric sphere present in water functions as a cavity, how an electric field of a WG mode distributes in a radial direction outside the cavity while depending on an argument mode number m or a relative refractive index nᵣ.

With reference to FIGS. 12A and 12B, in relation to a WG mode of a micro-dielectric sphere cavity present in water, a relationship between electric field intensity of the WG mode and a radial radius is illustrated. FIG. 12A illustrates a case where an argument mode number m is changed, and FIG. 12B illustrates a case where a relative refractive index nᵣ(n_{cav}/nₑₙᵥ, n_{cav}; refractive index inside cavity, nₑₙᵥ; refractive index outside cavity) is changed. In FIG. 12A, curved lines 1 to 7 correspond to cases where m=1, m=2, m=4, m=8, m=16, m=32, and m=64, respectively. In this case, a micro-dielectric sphere cavity is assumed to be sapphire (n_{cav}=1.7122), and a dispersion medium is assumed to be water (nₑₙᵥ=1.310), and thus a relative refractive index is nᵣ=1.308. Meanwhile, in FIG. 12B, curved lines 1 to 4 corresponds to nᵣ=1.083 (silicon oxide/water), nᵣ=1.308 (sapphire/water), nᵣ=2.619 (silicon/water), and nᵣ=4.566 (lead telluride (PbTe)/water). In FIG. 12B, all argument mode numbers are m=2. In both of FIGS. 12A and 12B, a value in which a wavelength is near 3 to 4 μm (corresponding to a wave number 3400 cm⁻¹ to 2500 cm⁻¹) in a middle infrared region was used for all relative refractive indexes. Note that, in a vertical axis, an absolute value |E_{z}| of electric field intensity in a direction perpendicular to an equatorial plane of a micro-dielectric sphere cavity is normalized by an absolute value |E_{z0}| of electric field intensity in the direction perpendicular to the equatorial plane of the micro-dielectric sphere cavity at an interface of the cavity, and, in a horizontal axis, a radial radius r is normalized by a resonance diameter D. Therefore, a range of 0≤r/D<0.5 represents the inside (hatched portion) of the micro-dielectric sphere cavity, and 0.5≤r/D represents the outside of the micro-dielectric sphere cavity from the interface. A numerical computation is performed on the range of 0.5≤r/D of the micro-dielectric sphere cavity from the interface, based on a next equation (9). Note that, the equation (9) holds true when a radial mode number is n=1.

$$\begin{matrix}[ Math 17 ] & \\ \vert {E}_{z} \vert = \vert {E}_{z 0} \vert exp [ - \{ {( m + \frac{1}{2} )}^{2} - {( \frac{m}{{n}_{r}} )}^{2} \} \frac{2 r}{D} ] & ( 9 )\end{matrix}$$

Hereinafter, knowledge acquired from FIGS. 12A and 12B will be described with five points exemplified below.

First, with reference to dependence on an argument mode number in FIG. 12A, a WG mode of the micro-dielectric sphere cavity has finite electric field intensity outside the sphere cavity even when the argument mode number is any value. Therefore, by using the leaking WG mode for vibrational coupling to a stretching vibrational mode of water, water present around the micro-dielectric sphere cavity can be always converted into ultra strong coupling water with at least one argument mode number in a range of 1≤m≤64.

Secondly, with reference to dependence on an argument mode number in FIG. 12A, as the argument mode number is smaller, a leaking electric field of the WG mode has a range thereof expanding in a radial direction, and intensity with the same radial radius is greater. In other words, as the argument mode number is smaller, the WG mode is more likely to leak to the outside of the sphere cavity. For example, in a case of “1” where m=1, leaking electric field intensity at r=1 has a half value of electric field intensity at the interface of the sphere cavity, and r=1.5, i.e., even at a place away from the interface by a resonance diameter, a leaking electric field maintains intensity equal to or more than ¼ of an interface electric field. On the other hand, in a case of “7” where m=64, a radial radius at which a leaking electric field has a half value is r=0.516 and closer to the interface. Therefore, in quantitative terms when water is converted into ultra strong coupling water, it is desirable to use a WG mode having a smallest possible argument mode number.

Thirdly, in FIG. 12A, nᵣ=1.308 of a combination of sapphire/water was used as a relative refractive index for a numerical computation. This value is coincidentally extremely close to nᵣ=1.310 being a relative refractive index of a combination of water/air. Therefore, dependence of a leaking electric field on an argument mode number in FIG. 12A is also applied to the micro-water sphere cavity floating in the air. When ultra strong coupling water is generated by using the micro-water sphere cavity, a WG mode localized inside the cavity is used for vibrational coupling, and thus a leaking WG mode may be as small as possible. Therefore, it is desirable that an argument mode number m is as great as possible for generating ultra strong coupling water by the micro-water sphere cavity. In other words, it is opposite for generating ultra strong coupling water by a micro-dielectric sphere cavity.

Fourthly, with reference to dependence on a relative refractive index in FIG. 12B, in any case of 1 to 4, an electric field of a WG mode extremely leaks out. For example, when r=1, |Ez|/|E_{z0}|≈0.4±0.05, i.e., a leaking electric field maintains about 40±5% of an interface electric field. Therefore, as long as at least relative refractive index is in a range of 1.083≤nᵣ≤4.566, water present around the micro-dielectric sphere cavity can be always converted into ultra strong coupling water.

Fifthly, with reference to dependence on a relative refractive index in FIG. 12B, as the relative refractive index increases, a leaking electric field of a WG mode becomes smaller. The reason is that, with a greater relative refractive index, total reflection is more likely to occur, and leaking of a WG mode is further reduced. However, dependence of a leaking electric field on a relative refractive index is relatively small. For example, even when a relative refractive index is changed by equal to or more than 4 times from a combination of silicon oxide/water (nᵣ=1.083) in “1” having the smallest relative refractive index to a combination of PbTe/water (nᵣ=4.566) in “4” having the greatest relative refractive index, a leaking electric field is reduced by only approximately 15%. Therefore, magnitude of a relative refractive index is not greatly affected in relation to generation of ultra strong coupling water. In other words, a material of the micro-dielectric sphere cavity can be selected from a wide variety of dielectrics.

As described above, the third example exemplified, by a numerical computation, that a leaking electric field of the micro-dielectric sphere cavity present in water can be used for generation of ultra strong coupling water. The third example clarified, from dependence of a leaking electric field range on an argument mode number m, that, in a case of the micro-dielectric sphere cavity present in water, ultra strong coupling water can be generated in a range of at least 1≤m≤64, and ultra strong coupling water can be manufactured in larger quantity with a smaller argument mode number. Conversely, the third example clarified that, in a case of the micro-water sphere cavity floating in the air, it is more suitable for generation of ultra strong coupling water with a greater argument mode number. Furthermore, the third example clarified, from dependence of a leaking electric field range on a relative refractive index nᵣ, that, in a case of the micro-dielectric sphere cavity present in water, ultra strong coupling water can be generated in a range of at least 1.083≤nᵣ<4.566, and a material of the micro-dielectric sphere cavity can be selected from a wide variety of dielectrics in generation of ultra strong coupling water since dependence of a leaking electric field range on a relative refractive index is relatively small.

### Fourth Example

A fourth example will describe how a relationship between a resonance diameter and a relative refractive index of a micro-dielectric sphere cavity needed for generating ultra strong coupling water changes by a difference in kinds (TE mode and TM mode) of deflection, kinds (light water and heavy water) of water, a radial mode number n, and an argument mode number m when water is a dispersion medium.

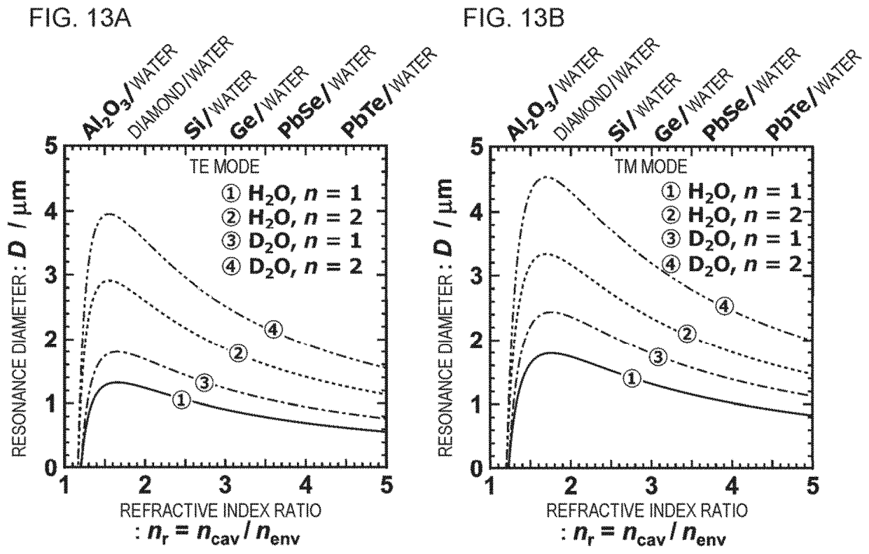

With reference to FIGS. 13A and 13B, a relationship between a resonance diameter D and a relative refractive index nᵣ (n_{cav}/nₑₙᵥ, n_{cav}; refractive index inside cavity, nₑₙᵥ; refractive index outside cavity) of a micro-dielectric sphere cavity is represented when water is a dispersion medium. FIG. 13A illustrates a case of the TE mode, and FIG. 13B illustrates a case of the TM mode. In both cases of FIGS. 13A and 13B, curved lines 1 to 4 respectively represent cases of light water (H₂O) and n=1, light water (H₂O) and n=2, heavy water (D₂O) and n=1, and heavy water (D₂O) and n=2, and an argument mode number m is m=1 in all of the cases. In both cases of FIGS. 13A and 13B, a perpendicular dotted line represents that the relative refractive index nᵣ is associated with nᵣ=1.308 (sapphire (Al₂O₃)/water), nᵣ=1.816 (diamond/water), nᵣ=2.623 (silicon (Si)/water), nᵣ=3.087 (germanium (Ge)/water), nᵣ=3.725 (lead selenide (PbSe)/water), and nᵣ=4.566 (lead telluride (PbTe)/water). All of the relative refractive indexes are values in which a wavelength is near 3 to 4 μm (corresponding to a wave number 3400 cm⁻¹ to 2500 cm⁻¹) in a middle infrared region. Similarly to the first and second examples, a numerical computation was performed based on the equations (4) to (8). Note that, a numerical computation was performed with a frequency of an OH stretching vibrational mode of light water (H₂O) being ω₀=3400 cm⁻¹ and a frequency of an OD stretching vibrational mode of heavy water (H₂O) being ω₀=2500 cm⁻¹.

Tables 5 to 8 summarize a result of performing a numerical computation on a resonance diameter of a micro-dielectric sphere cavity formed of various materials. Tables 5 and 6 illustrate a case where light water (H₂O) is a dispersion medium, and Tables 7 and 8 illustrate a case where heavy water (D₂O) is a dispersion medium. Each of the tables separately illustrates cases where kinds of polarization are a TE mode and a TM mode and an argument mode number m is m=1 and m=8. Note that, a radial mode number n is n=1 in all cases. In Tables 5 and 6, when a dielectric is a solid, the dielectric is used for colloid according to the present invention. An example in which a dielectric is a solid is as follows: at least one of magnesium fluoride (MgF₂), polydimethylsiloxane (PDMS), calcium fluoride (CaF₂), silicon oxide (SiO₂), barium fluoride (BaF₂), cellulose, polymethyl methacrylate (PMMA), polycarbonate, polystyrene, zinc oxide (ZnO), calcium carbonate (CaCO₃), magnesium oxide (MgO), polyimide, sapphire (Al₂O₃), tantalum pentoxide (Ta₂O₅), hafnium oxide (HfO₂), cadmium sulfide (CdS), gallium nitride (GaN), titanium oxide (TiO₂), diamond, silicon nitride (Si₃N₄), zinc selenide (ZnSe), cadmium selenide (CdSe), silicon carbide (SiC), cadmium telluride (CdTe), zinc telluride (ZnTe), gallium phosphide (GaP), indium phosphide (InP), boron carbide (B₄C), gallium arsenide (GaAs), silicon (Si), gallium antimonide (GaSb), indium antimonide (InSb), germanium (Ge), lead selenide (PbSe), and lead telluride (PbTe). When a dielectric is liquid, the dielectric is used for emulsion according to the present invention. An example in which the dielectric is liquid is as follows: at least one of octane, carbon tetrachloride (CCl₄), diethyl phthalate, benzene, dichlorobenzene, nitrobenzene, bromoform (CHBr₃), and carbon disulfide (CS₂).

TABLE 5

| MICRO- | RELATIVE | | | | |
|---|---|---|---|---|---|
| SPHERE | REFRACTIVE | RESONANCE DIAMETER [μm] | | | |
| CAVITY/ | INDEX: | (IN CASE OF LIGHT WATER (H₂O)) | | | |
| DISPERSION | nᵣ = | n = 1, m = 1 | | n = 1, m = 8 | |
| MEDIUM | n_{cav}/nₑₙᵥ | TE MODE | TM MODE | TE MODE | TM MODE |
| MgF₂/LIGHT WATER | 1.038 | N. A. | N. A. | 1.223 | 0.177 |
| OCTANE/LIGHT WATER | 1.048 | N. A. | N. A. | 3.488 | 2.656 |
| PDMS/LIGHT WATER | 1.054 | N. A. | N. A. | 4.371 | 3.641 |
| CaF₂/LIGHT WATER | 1.082 | N. A. | N. A. | 6.496 | 6.097 |
| SiO₂/LIGHT WATER | 1.083 | N. A. | N. A. | 6.539 | 6.149 |
| BF₂/LIGHT WATER | 1.115 | N. A. | N. A. | 7.402 | 7.238 |
| CCl₄/LIGHT WATER | 1.108 | N. A. | N. A. | 7.276 | 7.070 |
| CELLULOSE/LIGHT WATER | 1.115 | N. A. | N. A. | 7.402 | 7.238 |
| DIETHYL PHTHALATE/LIGHT WATER | 1.118 | N. A. | N. A. | 7.449 | 7.301 |
| PMMA/LIGHT WATER | 1.133 | N. A. | N. A. | 7.632 | 7.558 |
| BENZENE/LIGHT WATER | 1.133 | N. A. | N. A. | 7.632 | 7.558 |
| DICHLOROBENZENE/LIGHT WATER | 1.147 | N. A. | N. A. | 7.744 | 7.729 |
| NITROBENZENE/LIGHT WATER | 1.172 | N. A. | N. A. | 7.651 | 7.923 |
| POLYCARBONATE/LIGHT WATER | 1.194 | N. A. | N. A. | 7.882 | 8.015 |
| POLYSTYRENE/LIGHT WATER | 1.200 | N. A. | N. A. | 7.884 | 8.031 |
| BROMOFORM/LIGHT WATER | 1.201 | N. A. | N. A. | 7.884 | 8.034 |
| GeO₂/LIGHT WATER | 1.203 | N. A. | N. A. | 7.883 | 8.038 |
| CARBON DISULFIDE/LIGHT WATER | 1.212 | 0.1079 | N. A. | 7.879 | 8.054 |

TABLE 6

| MICRO- | RELATIVE | | | | |
|---|---|---|---|---|---|
| SPHERE | REFRACTIVE | RESONANCE DIAMETER [μm] | | | |
| CAVITY/ | INDEX: | (IN CASE OF LIGHT WATER (H₂O)) | | | |
| DISPERSION | nᵣ = | n = 1, m = 1 | | n = 1, m = 8 | |
| MEDIUM | n_{cav}/nₑₙᵥ | TE MODE | TM MODE | TE MODE | TM MODE |
| CaCO₃/LIGHT WATER | 1.237 | 0.3884 | 0.1291 | 7.846 | 8.069 |
| MgO/LIGHT WATER | 1.291 | 0.7829 | 0.7436 | 7.705 | 8.007 |
| POLYIMIDE/LIGHT WATER | 1.299 | 0.8248 | 0.8116 | 7.679 | 7.991 |
| SAPPHIRE/LIGHT WATER | 1.307 | 0.8634 | 0.8751 | 7.653 | 7.973 |
| LIGHT WATER/AIR | 1.310 | 0.8772 | 0.8978 | 7.643 | 7.966 |
| ZnO/LIGHT WATER | 1.487 | 1.266 | 1.606 | 6.973 | 7.400 |
| Ta₂O₅/LIGHT WATER | 1.533 | 1.297 | 1.678 | 6.799 | 7.236 |
| HfO₂/LIGHT WATER | 1.560 | 1.308 | 1.710 | 6.699 | 7.141 |
| CdS/LIGHT WATER | 1.721 | 1.318 | 1.791 | 6.141 | 6.594 |
| GaN/LIGHT WATER | 1.748 | 1.313 | 1.793 | 6.055 | 6.507 |
| TiO₂/LIGHT WATER | 1.807 | 1.300 | 1.790 | 5.873 | 6.323 |
| DIAMOND/LIGHT WATER | 1.816 | 1.298 | 1.789 | 5.846 | 6.296 |
| Si₃N₄/LIGHT WATER | 1.856 | 1.286 | 1.782 | 5.729 | 6.176 |
| ZnSe/LIGHT WATER | 1.860 | 1.285 | 1.781 | 5.718 | 6.165 |
| CdSe/LIGHT WATER | 1.874 | 1.281 | 1.778 | 5.678 | 6.124 |
| 4H—SiC/LIGHT WATER | 1.931 | 1.262 | 1.763 | 6.521 | 5.963 |
| CdTe/LIGHT WATER | 2.047 | 1.221 | 1.721 | 5.225 | 5.656 |
| ZnTe/LIGHT WATER | 2.065 | 1.215 | 1.714 | 5.181 | 5.610 |
| GaP/LIGHT WATER | 2.306 | 1.125 | 1.609 | 4.661 | 5.064 |
| InP/LIGHT WATER | 2.372 | 1.101 | 1.579 | 4.536 | 4.931 |
| B₄C/LIGHT WATER | 2.410 | 1.088 | 1.562 | 4.466 | 4.858 |
| GaAs/LIGHT WATER | 2.529 | 1.047 | 1.509 | 4.262 | 4.640 |
| SL/LIGHT WATER | 2.623 | 1.016 | 1.468 | 4.113 | 4.481 |
| GaSb/LIGHT WATER | 2.850 | 0.9473 | 1.375 | 3.792 | 4.138 |
| InSb/LIGHT WATER | 2.972 | 0.9134 | 1.328 | 3.639 | 3.973 |
| Ge/LIGHT WATER | 3.087 | 0.8832 | 1.286 | 3.506 | 3.830 |
| PbSe/LIGHT WATER | 3.725 | 0.7441 | 1.090 | 2.913 | 3.188 |
| PbTe/LIGHT WATER | 4.566 | 0.6138 | 0.9031 | 2.380 | 2.608 |

TABLE 7

| MICRO- | RELATIVE | | | | |
|---|---|---|---|---|---|
| SPHERE | REFRACTIVE | RESONANCE DIAMETER [μm] | | | |
| CAVITY/ | INDEX: | (IN CASE OF LIGHT WATER (D₂O)) | | | |
| DISPERSION | nᵣ = | n = 1, m = 1 | | n = 1, m = 8 | |
| MEDIUM | n_{cav}/nₑₙᵥ | TE MODE | TM MODE | TE MODE | TM MODE |
| MgF₂/LIGHT WATER | 1.038 | N. A. | N. A. | 1.664 | 0.240 |
| OCTANE/LIGHT WATER | 1.048 | N. A. | N. A. | 4.744 | 3.612 |
| PDMS/LIGHT WATER | 1.054 | N. A. | N. A. | 5.945 | 4.952 |
| CaF₂/LIGHT WATER | 1.082 | N. A. | N. A. | 8.835 | 8.292 |
| SiO₂/LIGHT WATER | 1.083 | N. A. | N. A. | 8.893 | 8.363 |
| BF₂/LIGHT WATER | 1.115 | N. A. | N. A. | 10.067 | 9.843 |
| CCl₄/LIGHT WATER | 1.108 | N. A. | N. A. | 9.696 | 9.615 |
| CELLULOSE/LIGHT WATER | 1.115 | N. A. | N. A. | 10.067 | 9.843 |
| DIETHYL PHTHALATE/LIGHT WATER | 1.118 | N. A. | N. A. | 10.131 | 9.929 |
| PMMA/LIGHT WATER | 1.133 | N. A. | N. A. | 10.380 | 10.279 |
| BENZENE/LIGHT WATER | 1.133 | N. A. | N. A. | 10.380 | 10.279 |
| DICHLOROBENZENE/LIGHT WATER | 1.147 | N. A. | N. A. | 10.532 | 10.512 |
| NITROBENZENE/LIGHT WATER | 1.172 | N. A. | N. A. | 10.678 | 10.775 |
| POLYCARBONATE/LIGHT WATER | 1.194 | N. A. | N. A. | 10.720 | 10.901 |
| POLYSTYRENE/LIGHT WATER | 1.200 | N. A. | N. A. | 10.722 | 10.922 |
| BROMOFORM/LIGHT WATER | 1.201 | N. A. | N. A. | 10.722 | 10.926 |
| GeO₂/LIGHT WATER | 1.203 | N. A. | N. A. | 10.721 | 10.932 |

TABLE 8

| MICRO- | RELATIVE | | | | |
|---|---|---|---|---|---|
| SPHERE | REFRACTIVE | RESONANCE DIAMETER [μm] | | | |
| CAVITY/ | INDEX: | (IN CASE OF LIGHT WATER (D₂O)) | | | |
| DISPERSION | nᵣ = | n = 1, m = 1 | | n = 1, m = 8 | |
| MEDIUM | n_{cav}/nₑₙᵥ | TE MODE | TM MODE | TE MODE | TM MODE |
| CARBON DISULFIDE/HEAVY WATER | 1.212 | 0.147 | N.A | 10.715 | 10.953 |
| CaCO₃/HEAVY WATER | 1.237 | 0.5282 | 0.1756 | 10.670 | 10.974 |
| MgO/HEAVY WATER | 1.291 | 1.065 | 1.011 | 10.479 | 10.890 |
| POLYIMIDE/HEAVY WATER | 1.299 | 1.122 | 1.104 | 10.444 | 10.867 |
| SAPPHIRE/HEAVY WATER | 1.307 | 1.174 | 1.190 | 10.408 | 10.843 |
| HEAVY WATER/AIR | 1.310 | 1.193 | 1.221 | 10.394 | 10.833 |
| ZnO/HEAVY WATER | 1.487 | 1 722 | 2.164 | 9.484 | 10.063 |
| Ta₂O₅/HEAVY WATER | 1.533 | 1.763 | 2.283 | 9.246 | 9.841 |
| HfO₂/HEAVY WATER | 1.560 | 1.779 | 2.325 | 9.110 | 9.711 |
| CdS/HEAVY WATER | 1.721 | 1.792 | 2.436 | 8.352 | 8.967 |
| GaN/HEAVY WATER | 1.748 | 1.788 | 2.438 | 8.234 | 8.849 |
| TiO₂/HEAVY WATER | 1.807 | 1.768 | 2.435 | 7.987 | 8.599 |
| DIAMOND/HEAVY WATER | 1.816 | 1.765 | 2.433 | 7.951 | 8.562 |
| Si₃N₄/HEAVY WATER | 1.856 | 1.749 | 2.424 | 7.792 | 8.400 |
| ZnSe/HEAVY WATER | 1.860 | 1.748 | 2.423 | 7.776 | 8.384 |
| CdSe/HEAVY WATER | 1.874 | 1.742 | 2.418 | 7.722 | 8.329 |
| 4H—SiC/HEAVY WATER | 1.931 | 1.717 | 2.397 | 7.508 | 8.109 |
| CdTe/HEAVY WATER | 2.047 | 1.661 | 2.341 | 7.106 | 7.692 |
| ZnTe/HEAVY WATER | 2.065 | 1.652 | 2.331 | 7.047 | 7.630 |
| GaP/HEAVY WATER | 2.306 | 1.530 | 2.188 | 6.339 | 6.887 |
| InP/HEAVY WATER | 2.372 | 1.498 | 9.147 | 6.168 | 6.706 |
| B₄C/HEAVY WATER | 2.410 | 1.480 | 2.124 | 6.074 | 6.606 |
| GaAs/HEAVY WATER | 2.529 | 1.424 | 2.052 | 5.796 | 6.311 |
| Si/HEAVY WATER | 2.623 | 1.382 | 1.996 | 5.594 | 6.095 |
| GaSb/HEAVY WATER | 2.850 | 1.288 | 1.870 | 5.158 | 5.627 |
| InSb/HEAVY WATER | 2.972 | 1.242 | 1.806 | 4.950 | 5.404 |
| Ge/HEAVY WATER | 3.087 | 1.201 | 1.749 | 4.768 | 5.208 |
| PbSe/HEAVY WATER | 3.725 | 1.012 | 1.483 | 3.961 | 4.335 |
| pbTe/HEAVY WATER | 4.566 | 0.8347 | 1.228 | 3.237 | 3.547 |

Knowledge acquired from FIGS. 13A and 13B and Tables 5 to 8 will be described with five points exemplified below.

First, with reference to FIGS. 13A and 13B, as a relative refractive index increases, a resonance diameter needed for generating ultra strong coupling water temporarily suddenly increases, then reaches a local maximum value, and gently decreases regardless of kinds of water, kinds of deflection, and a radial mode number. With reference to FIGS. 13A and 13B, in any case of light water, heavy water, n=1 and n=2 of a radial mode number, and a TE mode and a TM mode of kinds of polarization, when an argument mode number m is m=1, a resonance diameter becomes local maximum near nᵣ=1.6. On the other hand, with reference to Tables 5 and 6, when m=8, a resonance diameter becomes local maximum near nᵣ=1.2. In other words, as an argument mode number increases, a local maximum resonance diameter shifts toward a smaller relative refractive index. Furthermore, with reference to Tables 5 to 8, when m=1, the equations (4) to (8) do not provide a physically significant value (displayed as N.A. in the tables) with a relative refractive index nᵣ in a range of approximately nᵣ<1.21. The reason is that, when m=1, a resonance diameter is small, and a total reflection condition being a premise of formation of a WG mode in a microsphere cavity does not hold true. On the other hand, when m=8, a resonance diameter is great, and the total reflection condition holds true. In fact, as illustrated in Tables 5 and 6, when m=8, the equations (4) to (8) provide a rational value. Therefore, when a relative refractive index is in a range of nᵣ<1.21, an argument mode number in a range of m≥8 needs to be selected. Meanwhile, an argument mode number is not limited as long as a relative refractive index is in a range of nᵣ≥1.21.

Secondly, a permissible range of a resonance diameter needed for generating ultra strong coupling water will be described. FIGS. 13A and 13B and Tables 5 to 8 illustrate only “perfect match” related to a resonance diameter, and do not illustrate “match in half-value width” as exemplified in the first example. The reason is to avoid complicatedness of the diagrams. In fact, there is also a permissible range of a resonance diameter in the present example, which is the same as the first example. In other words, a permissible range of a resonance diameter is ±5.9% in a case of light water, and is ±6.4% in a case of heavy water.

Thirdly, in FIGS. 13A and 13B, when a resonance diameter needed for generating ultra strong coupling water is compared, a resonance diameter is smaller in a case of heavy water than in a case of light water. The reason, which is as described in the first example, is that a wavelength of a WG mode is longer in a stretching vibrational mode of heavy water than in a stretching vibrational mode of light water. In any case, a coupling ratio Ω_{R}/2ω₀ of ultra strong coupling water rarely changes when light water or heavy water is used, and thus any of light water, heavy water, and a mixed liquid thereof may be used for generating ultra strong coupling water.

Fourthly, in FIGS. 13A and 13B, when a resonance diameter needed for generating ultra strong coupling water is compared, a resonance diameter is greater in a case of the TM mode than in a case of the TE mode. The reason, which is as described in the first example, is that the TE mode always resonates at a shorter wavelength than the TM mode, and thus the TE mode accordingly always has a smaller resonance diameter than that of the TM mode. In any case, a capacity for generating ultra strong coupling water does not change, and thus either the TE mode or the TM mode may be used for generating ultra strong coupling water.

Fifthly, with reference to Tables 5 to 8, Tables 5 to 8 exemplify that, when water is a dispersion medium, a micro-dielectric sphere cavity with a variety of dielectrics as a material can be used for generating ultra strong coupling water. The reason is that a necessary condition is only a resonance diameter and a relative refractive index. As described above, any dielectric may be used as long as a relative refractive index is approximately nᵣ≥1.21. A refractive index of water is nₑₙᵥ=1.310, and is thus approximately n_{cav}≥1.59 when the refractive index of water is converted into a refractive index of a cavity n_{cav}. On the other hand, in a case where nᵣ<1.21, any dielectric can be used for the present invention by using an argument mode number in a range of m≥8.

As described above, the fourth example clarified dependence, on kinds of deflection, kinds of water, a radial mode number, and an argument mode number, of a relationship between a resonance diameter and a relative refractive index of a micro-dielectric sphere cavity needed for generating ultra strong coupling water when water is a dispersion medium. The fourth example clarified that, with m=1 being used as an argument mode number, a relative refractive index needs to be in a range of approximately nᵣ≥1.21 for generating ultra strong coupling water, whereas, with m≥8 being used, a relative refractive index is not limited in a practical range.

### Fifth Example

A fifth example describes, for aerosol with a liquid other than pure water as a dispersoid, a resonance diameter in which a micro-liquid sphere cavity floating in the air needs to have in order for the liquid to be brought in a vibrational coupling state. Further, the fifth example simultaneously describes, for emulsion or colloid with a liquid other than pure water as a dispersion medium, a resonance diameter in which a micro-dielectric sphere cavity present in a liquid other than water needs to have in order to convert the liquid into a vibrational coupling state.

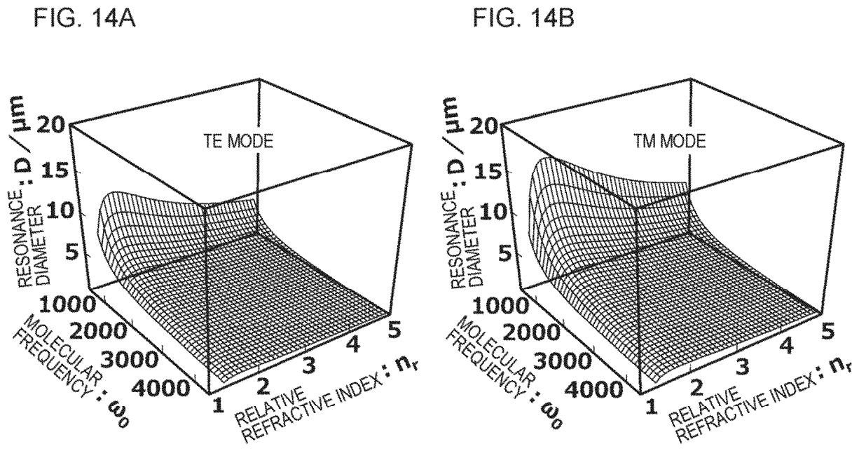

With reference to FIGS. 14A and 14B, a resonance diameter D of a microsphere cavity needed for converting liquid into a vibrational coupling state is three-dimensionally plotted with, as two variables, a molecular frequency ω₀ and a relative refractive index nᵣ(n_{cav}/nₑₙᵥ, n_{cav}; refractive index inside cavity, nₑₙᵥ; refractive index outside cavity) of the liquid. A domain is 400≤ω₀<4400 cm⁻¹ for the molecular frequency ω₀ and 1≤nᵣ<5 for the relative refractive index nᵣ, and a range is 0≤D<20 for the resonance diameter D. FIG. 14A is associated with a case of a TE mode, and FIG. 14B is associated with a case of a TM mode. In both of FIGS. 14A and 14B, a radial mode number n is n=1, and an argument mode number m is m=1. Similarly to the first, second, and fourth examples, a numerical computation was performed based on the equations (4) to (8). Tables 9 and 10 describe, for a liquid having a coupling ratio of Ω_{R}/2ω₀ of vibrational coupling being actually measured, a resonance diameter of a microsphere cavity for bringing the liquid into a vibrational coupling state in a case of a micro-liquid sphere cavity (aerosol in which a dispersoid is a micro-liquid sphere and a dispersion medium is air/nₑₙᵥ=1.0003) and a case of a micro-dielectric sphere cavity (colloid in which a dispersoid is micro-silicon (Si) sphere/n_{cav}=3.4361 and a dispersion medium is the liquid).

Table 9 illustrates a case of the TE mode and n=m=1, and Table 10 illustrates a case of the TM mode and n=m=1. Note that, a value in a middle infrared region was used for a refractive index of the liquid. Note that, kinds of the liquid described above are as follows: blood (water content 90%), hydrogen peroxide solution (aqueous solution of hydrogen peroxide (H₂O₂), water content 66%), formalin (aqueous solution of formaldehyde (HCHO), water content 50%), glycerin (glycerol, HOCH₂CH(OH)CH₂OH), methanol (CH₃OH), 2-propanol (isopropyl alcohol, (CH₃)₂CHOH), 2-methyl-2-propanol (t-butyl alcohol, (CH₃)₃COH), phenyl isocyanate (Ph-NCO), acetone ((CH₃)₂CO), N,N-dimethylformamide (DMF, (CH₃)₂NCHO), and carbon disulfide (CS₂).

TABLE 9

| | | | | | RESONANCE | |
|---|---|---|---|---|---|---|
| | | | | | DIAMETER [μm] | |
| | | | | | TE MODE, n = m = 1 | |
| | | MOLECULAR | COUPLING | | AEROSOL | COLLOID/ |
| | | FREQUENCY | RATIO | REFRACTIVE | (DISPERSION | EMULSION |
| | VIBRATIONAL | ω₀ | Ω_{R}/ | INDEX | MEDIUM: | (DISPERSOID: |
| LIQUID | MODE | [cm⁻¹] | 2ω₀ | OF LIQUID | AIR) | SILICON) |
| BLOOD (WATER 90%) | OH | 3400 | 0.107 | 1.375 | 1.095 | 1.057 |
| | STRETCHING | | | | (IN CASE | |
| | | | | | OF BLOOD | |
| | | | | | PLASMA) | |
| HYDROGEN PEROXIDE | OH | 3400 | 0.099 | 1.320 | 0.9186 | 1.023 |
| SOLUTION (WATER 66%) | STRETCHING | | | | | |
| FORMALIN (WATER 50%) | OH | 3350 | 0.095 | 1.350 | 1.041 | 1.057 |
| | STRETCHING | | | | | |
| GLYCERIN | OH | 3350 | 0.075 | 1.463 | 1.261 | 1.126 |
| | STRETCHING | | | | | |
| METHANOL | OH | 3350 | 0.064 | 1.317 | 0.9198 | 1.036 |
| | STRETCHING | | | | | |
| 2-PROPANOL | OH | 3350 | 0.048 | 1.365 | 1.085 | 1.067 |
| | STRETCHING | | | | | |
| 2-METHYL-2-PROPANOL | OH | 3350 | 0.040 | 1.386 | 1.137 | 1.080 |
| | STRETCHING | | | | | |
| PHENYL ISOCYANATE | N═C═O | 2270 | 0.069 | 1.510 | 1.922 | 1.702 |
| | STRETCHING | | | | | |
| ACETONE | C═O | 1730 | 0.043 | 1.348 | 2.004 | 2.045 |
| | STRETCHING | | | | | |
| N,N-DIMETHYLFORMAMIDE | C═O | 1670 | 0.030 | 1.415 | 2.397 | 2.202 |
| | STRETCHING | | | | | |
| CARBON DISULFIDE (CS₂) | S═C═S | 1520 | 0.094 | 1.588 | 2.944 | 2.635 |
| | STRETCHING | | | | | |

TABLE 10

| | | | | | RESONANCE | |
|---|---|---|---|---|---|---|
| | | | | | DIAMETER [μm] | |
| | | | | | TM MODE, n = m = 1 | |
| | | MOLECULAR | COUPLING | | MICRO-LIQUID | MICRO-DIELECTRIC |
| | | FREQUENCY | RATIO | REFRACTIVE | SPHERE CAVITY | SPHERE CAVITY |
| | VIBRATIONAL | ω₀ | Ω_{R}/ | INDEX | (DISPERSION | (DISPERSOID: |
| LIQUID | MODE | [cm⁻¹] | 2ω₀ | OF LIQUID | MEDIUM: AIR) | SILICON) |
| BLOOD (WATER 90%) | OH | 3400 | 0.107 | 1.375 | 1.273 | 1.522 |
| | STRETCHING | | | | (IN CASE | |
| | | | | | OF BLOOD | |
| | | | | | PLASMA) | |
| HYDROGEN PEROXIDE | OH | 3400 | 0.099 | 1.320 | 0.9667 | 1.476 |
| SOLUTION (WATER 66%) | STRETCHING | | | | | |
| FORMALIN (WATER 50%) | OH | 3350 | 0. 095 | 1.350 | 1.167 | 1.524 |
| | STRETCHING | | | | | |
| GLYCERIN | OH | 3350 | 0.075 | 1.463 | 1.570 | 1.613 |
| | STRETCHING | | | | | |
| METHANOL | OH | 3350 | 0.064 | 1.317 | 0.9599 | 1.496 |
| | STRETCHING | | | | | |
| 2-PROPANOL | OH | 3350 | 0.048 | 1.365 | 1.245 | 1.536 |
| | STRETCHING | | | | | |
| 2-METHYL-2-PROPANOL | OH | 3350 | 0.040 | 1.386 | 1.339 | 1.554 |
| | STRETCHING | | | | | |
| PHENYL ISOCYANATE | N═C═O | 2270 | 0.069 | 1.510 | 2.464 | 1.430 |
| | STRETCHING | | | | | |
| ACETONE | C═O | 1730 | 0.043 | 1.348 | 2.239 | 2.948 |
| | STRETCHING | | | | | |
| N,N-DIMETHYLFORMAMIDE | C═O | 1670 | 0.030 | 1.415 | 2.901 | 3.163 |
| | STRETCHING | | | | | |
| CARBON DISULFIDE (CS₂) | S═C═S | 1520 | 0.094 | 1.588 | 3.881 | 3.741 |
| | STRETCHING | | | | | |

Hereinafter, knowledge acquired from FIGS. 14A and 14B, Tables 9 and 10, and the equations (4) to (8) will be described with eight points exemplified below.

First, with reference to FIGS. 14A and 14B, with the same molecular frequency and relative refractive index, a resonance diameter of a microsphere cavity needed for converting a liquid other than water into a vibrational coupling state tends to be smaller in the TE mode than in the TM mode. This tendency is the same as a tendency of a resonance diameter of a microsphere cavity needed for generating ultra strong coupling water. To simply state the reason, the reason is that the TE mode always resonates at a shorter wavelength than the TM mode, and thus the TE mode accordingly always has a smaller resonance diameter than that of the TM mode. In any case, a capacity for generating ultra strong coupling water does not change, and thus either the TE mode or the TM mode may be used for generating ultra strong coupling water.

Secondly, with reference to FIGS. 14A and 14B, when a molecular frequency is fixed, a resonance diameter of a microsphere cavity needed for converting a liquid other than water into a vibrational coupling state tends to suddenly increase with a relative refractive index in a range of approximately 1<nᵣ<1.5, then take a local maximum value near nᵣ=1.5, and gently decrease with the relative refractive index in a range of 1.5<nᵣ. This tendency is the same as a tendency of a resonance diameter of a microsphere cavity needed for generating ultra strong coupling water. As described above, when aerosol in which a dispersoid is a micro-liquid sphere cavity and a dispersion medium is gas is manufactured, magnitude of a relative refractive index is not limited. Further, when colloid or emulsion in which a dispersoid is a micro-dielectric sphere cavity and a dispersion medium is liquid is manufactured, a relative refractive index needs to be in a range of nᵣ≥1.21 when an argument mode number m is m=1, whereas magnitude of a relative refractive index is not limited as long as m≥8.

Thirdly, with reference to FIGS. 14A and 14B, when a relative refractive index is fixed, a resonance diameter of a microsphere cavity needed for converting a liquid other than water into a vibrational coupling state tends to monotonously decrease as a molecular frequency increases. This tendency is the same as a tendency that a resonance diameter of a microsphere cavity needed for generating ultra strong coupling water is smaller in a case of light water (H₂O) than in a case of heavy water (D₂O). In other words, the reason is that a wavelength of a WG mode is inversely proportional to a frequency, and thus a resonance diameter increases.

Fourthly, according to the equations (4) to (8), with the same molecular frequency and relative refractive index, a resonance diameter of a microsphere cavity needed for converting a liquid other than water into a vibrational coupling state tends to be smaller when n=1 of a radial mode number n than when n=2. This tendency is the same as a tendency of a resonance diameter of a microsphere cavity needed for generating ultra strong coupling water. To simply state a reason, the reason is that, in the equation (4), a contribution of the Airy function in the equation (7) is greater when n=2 than when n=1. In any case, efficiency for converting a liquid other than water into a vibrational coupling state does not change even when any radial mode number is used, and thus either n=1 or n=2 may be used for converting a liquid other than water into a vibrational coupling state.

Fifthly, according to the equations (4) to (8), with the same molecular frequency and relative refractive index, a resonance diameter of a microsphere cavity needed for converting a liquid other than water into a vibrational coupling state tends to be greater as an argument mode number m increases. This tendency is the same as a tendency of a resonance diameter of a microsphere cavity needed for generating ultra strong coupling water. In any case, efficiency for converting a liquid other than water into a vibrational coupling state does not depend on an argument mode number, and thus any argument mode number may be used for converting a liquid other than water into a vibrational coupling state.

Sixthly, a permissible range of a resonance diameter needed for generating a liquid in a vibrational coupling state will be described. FIGS. 14A and 14B and Tables 9 and 10 illustrate only “perfect match” related to a resonance diameter, and do not illustrate “match in half-value width” as exemplified in the first example. The reason is to avoid complicatedness of the diagrams. In fact, there is also a permissible range of a resonance diameter in the present example. When a liquid other than water is used, a half-value width of a vibrational mode is approximately 1/50 of a molecular frequency, and thus a permissible range of a resonance diameter is ±1%. A permissible range of a resonance diameter for an aqueous solution and a mixed liquid containing water is ±5.9% when vibrational coupling is performed on an OH stretching vibration, and is ±6.4% when vibrational coupling is performed on an OD stretching vibration.

Seventhly, with reference to Tables 9 and 10, Tables 9 and 10 exemplify that, by using a microsphere cavity according to the present invention, aerosol in which a liquid in a vibrational coupling state is a dispersoid and colloid in which a liquid in a vibrational coupling state is a dispersion medium can be achieved by a variety of liquids. The reason is that a necessary condition is only a resonance diameter and a relative refractive index. For example, not only a liquid of glycerin, methanol, 2-propanol, 2-methyl-2-propanol, phenyl isocyanate, or acetone, but also an aqueous solution such as hydrogen peroxide solution and formalin and furthermore a mixing liquid including various solutes and dispersoids, such as blood, may be used. In this way, aerosol, colloid, and emulsion in a vibrational coupling state can be manufactured for a wide variety of kinds of liquids from a pure liquid to a solution and a mixed liquid.

Eighthly, with reference to Tables 9 and 10, the present invention does not select a vibrational mode and a molecular frequency. For example, aerosol, colloid, and emulsion in a vibrational coupling state can be manufactured for a liquid having a variety of vibrational modes and molecular frequencies, such as an OH stretching vibrational mode (ω₀=3350, 3400 cm⁻¹), an N═C═O stretching vibrational mode (ω₀=2270 cm⁻¹), a C═O stretching vibrational mode ((ω₀=1670, 1730 cm⁻¹), and an S═C═S stretching vibrational mode (ω₀=1520 cm⁻¹).

As described above, the fifth example clarified how a resonance diameter needed for bringing a liquid other than pure water into a vibrational coupling state depends on a molecular frequency, a relative refractive index, kinds of deflection, a radial mode number, and an argument mode number, with regard to aerosol in which gas such as air is a dispersion medium and a liquid other than pure water constitutes a micro-liquid sphere cavity and is a dispersoid, and colloid or emulsion in which a liquid other than pure water is a dispersion medium and a micro-dielectric sphere cavity is a dispersoid. In this way, the fifth example proved that aerosol, colloid, and emulsion in a vibrational coupling state can be manufactured for a wide variety of kinds of liquids from a pure liquid to a solution and a mixed liquid.

### INDUSTRIAL APPLICABILITY

As an application example of the present invention, the whole industrial field using physical/chemical properties of liquid typified by water is exemplified. Particularly, utilization and application can be expected in a wide industrial field from a manufacturing industrial field using a chemical reaction in which liquid typified by water is involved to a health care/medical/pharmaceutical field.

This application is based upon and claims the benefit of priority from Japanese patent application No. 2019-053611, filed on Mar. 20, 2019, the disclosure of which is incorporated herein in its entirety by reference.

### REFERENCE SIGNS LIST

11 Equator
12 Microsphere
13 TE mode
14 Origin
15 xyz coordinates
16 TM mode
20 Equator
21 Distribution of light intensity in direction perpendicular to equatorial plane
30 Fabry-Perot cavity
31 Substrate
32 Metal film mirror surface
33 Protective film
34 Spacer
35 Water
36 Cavity length
37 Equator (great circle)
38 Resonance diameter
39 Enlarged view
40 WG mode
41 Micro-water sphere
42 Dispersion medium
43 Aerosol with micro-water sphere cavity as dispersoid
50 Micro-water sphere cavity
51 Dispersion medium such as air
52 Aerosol with micro-water sphere cavity as dispersoid
53 Micro-dielectric sphere cavity
54 Region of bulk water
55 Region of ultra strong coupling water
56 Colloid or emulsion with micro-dielectric sphere cavity as dispersoid
57 Water molecule (vibrational ultra strong coupling state)
58 Raw material molecule (carbon dioxide)
59 Product molecule (methanol, oxygen)
60 Resonance diameter observation apparatus
61 Humidification apparatus
62 Heating/cooling apparatus
63 Decompression/compression apparatus
64 Control signal cable
65 Reaction container
66 Aerosol generation apparatus
67 Raw material supply apparatus
68 Product separation apparatus
69 Product collection container
70 Pipe
71 Introduction port
72 Discharge port
73 Chemical reaction system using micro-water sphere cavity
80 Micro-dielectric sphere supply apparatus
81 Mixing apparatus
82 Water supply apparatus
83 Pipe
84 Raw material supply apparatus
85 Reaction container
86 Stirrer
87 Micro-dielectric sphere collection pipe
88 Micro-dielectric sphere separation apparatus
89 Product separation apparatus
90 Product collection container
91 Introduction port
92 Discharge port
93 Batch-type chemical reaction system using micro-dielectric sphere cavity
94 Mixing apparatus
95 Reaction column
96 Compression apparatus
97 Mixed liquid
98 Filler formed of micro-dielectric sphere cavity
99 Loop pipe
100 Continuous-type chemical reaction system using micro-dielectric sphere cavity

What is claimed is:

1. A dispersion system, comprising
a spherical body, as a dispersoid, formed of a liquid in a vibrational coupling state, wherein
a whispering gallery mode which the spherical body of the liquid spontaneously forms and a vibrational mode of the liquid are resonantly coupled to each other.

2. A dispersion system, comprising:
a spherical body that serves as a dispersoid, and is formed of a dielectric;
a liquid being a dispersion medium of the spherical body, wherein
a whispering gallery mode which the spherical body of the dielectric spontaneously forms and a vibrational mode of the liquid are resonantly coupled to each other.

3. The dispersion system according to claim 2, wherein
the dispersion system is colloid, and
the dielectric is at least one of magnesium fluoride (MgF₂), polydimethylsiloxane (PDMS), calcium fluoride (CaF₂), silicon oxide (SiO₂), barium fluoride (BaF₂), cellulose, polymethyl methacrylate (PMMA), polycarbonate, polystyrene, zinc oxide (ZnO), calcium carbonate (CaCO₃), magnesium oxide (MgO), polyimide, sapphire (Al₂O₃), tantalum pentoxide (Ta₂O₅), hafnium oxide (HfO₂), cadmium sulfide (CdS), gallium nitride (GaN), titanium oxide (TiO₂), diamond, silicon nitride (Si₃N₄), zinc selenide (ZnSe), cadmium selenide (CdSe), silicon carbide (SiC), cadmium telluride (CdTe), zinc telluride (ZnTe), gallium phosphide (GaP), indium phosphide (InP), boron carbide (B₄C), gallium arsenide (GaAs), silicon (Si), gallium antimonide (GaSb), indium antimonide (InSb), germanium (Ge), lead selenide (PbSe), and lead telluride (PbTe).

4. The dispersion system according to claim 2, wherein
the dispersion system is emulsion, and
the dielectric is at least one of octane, carbon tetrachloride (CCl₄), diethyl phthalate, benzene, dichlorobenzene, nitrobenzene, bromoform (CHBr₃), and carbon disulfide (CS₂).

5. The dispersion system according to claim 1, wherein the liquid is water.

6. The dispersion system according to claim 5, wherein
the water is light water (H₂O), heavy water (D₂O), tritiated water (T₂O), and a mixed liquid including two or more kinds of water selected from light water (H₂O), heavy water (D₂O), and tritiated water (T₂O).

7. A treatment method, comprising
using the dispersion system according to claim 1 for a chemical reaction.

8. A chemical reaction apparatus being used in the treatment method according to claim 7, the chemical reaction apparatus comprising at least
a reaction container in which the chemical reaction is performed;
an introduction port for introducing the dispersion system into the reaction container; and
a discharge port for discharging a reactant by the chemical reaction.

9. The chemical reaction apparatus according to claim 8, further comprising a column in which the spherical body fills.
